(19) United States
(12) Patent Application Publication
(10) Pub. No.: US 2008/0281766 A1
(43) Pub. Date: Nov. 13, 2008

(54) Time Machine Software

(76) Inventor: Mitchell Kwok, Honolulu, HI (US)

Correspondence Address: Mitchell Kwok, 1675 Kamamalu Ave., Honolulu, HI, 96813, US

(21) Appl. No.: 12/135,132

(22) Filed: Jun. 6, 2008

Related U.S. Application Data
(63) Continuation-in-part of application No. 12/129,231, filed on May 29, 2008.
Application No. 12/129,231 is a continuation-in-part of application No. 12/110,313, filed on Apr. 26, 2008.
Application No. 12/110,313 is a continuation-in-part of application No. 12/014,742, filed on Jan. 15, 2008.
Application No. 12/014,742 is a continuation-in-part of application No. 11/936,725, filed on Nov. 7, 2007.
Application No. 11/936,725 is a continuation-in-part of application No. 11/770,734, filed on Jun. 29, 2007.
Application No. 11/770,734 is a continuation-in-part of application No. 11/744,767, filed on May 4, 2007.
(60) Provisional application No. 61/042,733, filed on Apr. 5, 2008.
(60) Provisional application No. 61/035,645, filed on Mar. 11, 2008.
(60) Provisional application No. 61/028,885, filed on Feb. 14, 2008.
(60) Provisional application No. 61/015,201, filed on Dec. 20, 2007.
(60) Provisional application No. 60/909,437, filed on Mar. 31, 2007.

(51) Int. Cl. G06F 15/18; G05B 19/04; G06N 5/02; G06N 5/04; G06F 9/44; G06F 17/30

(52) U.S. Cl. 706/12; 700/246; 706/50; 706/48; 718/1; 707/3

(57) ABSTRACT

A method and system for creating human robots with psychic abilities, as well as enabling a human robot to access information in a time machine to predict the future accurately and realistically. The present invention provides a robot with the ability to accomplish tasks quickly and accurately without using any time. This permits a robot to cure cancer, fight a war, write software, read a book, learn to drive a car, draw a picture or solve a complex math problem in less than one second.

### CROSS REFERENCE TO RELATED APPLICATIONS

This application claims the benefit of U.S. Provisional Application No. 61/042,733, filed on Apr. 5, 2008, this application is also a Continuation-in-Part application of U.S. Ser. No. 12/129,231, filed on May 29, 2008, entitled: Human Artificial Intelligence Machine, which claims the benefit of U.S. Provisional Application No. 61/035,645, filed on Mar. 11, 2008, which is a Continuation-in-Part application of U.S. Ser. No. 12/110,313, filed on Apr. 26, 2008, entitled: Human Level Artificial Intelligence Machine, which claims the benefit of U.S. Provisional Application No. 61/028,885 filed on Feb. 14, 2008, which is a Continuation-in-Part application of U.S. Ser. No. 12/014,742, filed on Jan. 15, 2008, entitled: Human Artificial Intelligence Software Program, which claims the benefit of U.S. Provisional Application No. 61/015,201 filed on Dec. 20, 2007, which is a Continuation-in-Part application of U.S. Ser. No. 11/936,725, filed on Nov. 7, 2007, entitled: Human Artificial Intelligence Software Application for Machine & Computer Based Program Function, which is a Continuation-in-Part application of U.S. Ser. No. 11/770,734, filed on Jun. 29, 2007 entitled: Human Level Artificial Intelligence Software Application for Machine & Computer Based Program Function, which is a Continuation-in-Part application of U.S. Ser. No. 11/744,767, filed on May 4, 2007 entitled: Human Level Artificial Intelligence Software Application for Machine & Computer Based Program Function, which claims the benefit of U.S. Provisional Application No. 60/909,437, filed on Mar. 31, 2007.

### STATEMENT REGARDING FEDERALLY SPONSORED RESEARCH OR DEVELOPMENT

(Not applicable)

### BACKGROUND OF THE INVENTION

1. Field of the Invention

This invention relates generally to the field of artificial intelligence. Moreover it pertains specifically to robots and machines thousands of times smarter than human beings.

2. Description of Related Art

People who have psychic abilities such as predicting the future or communicating with the dead have been fascinating people all around the world. But, where exactly do they get their abilities from? Most psychics claim people from the spirit world passes on knowledge to them in terms of 5 sense data such as images, sound, tastes, touch or smell.

Human level artificial intelligence is a term used in AI to describe a machine that has human intelligence. A more advance type of robot would be machines that have psychic abilities. They are considered “robots that can think thousands of times smarter than a human being”. There is no prior art that relates to robots that have psychic abilities.

### SUMMARY OF THE INVENTION

A robot that can think thousands of times smarter than a human being will have heightened senses that will allow it to do things that no human being can do. The present invention provide a method to instill “psychic abilities” into human robots so that they can predict a future event, give facts about an unknown object, solve a complex problem, or solve a crime.

Imagine that a robot is sitting down next to a human being and the robot has never seen this person before or know any facts about this person. Upon seeing the person the robot knows everything about him including his name, his phone number, where he lives, his past history, what he is currently thinking, what kind of dream he had two weeks ago and “all” facts about this person. Even facts that only this person would know is extracted.

Imagine that a robot is given an assignment to find a cure for cancer and to write a book about how the cure is developed. In less than one second the robot is able to find a cure for cancer. No physical work has been done to find a cure. Within this one second the robot has a pdf file in his home computer that outlines the cure for cancer. The entire human race for the last 100 years can't find a cure for cancer and yet this machine was able to find a cure in less than 1 second.

Imagine that a robot is given an assignment to solve a crime. Little facts about the case is given to the robot. The robot will solve the crime in less than one second. No investigation is required or no interrogation of suspects is required. At the end of one second the robot will have all the information that will point out who committed the criminal, where the criminal is located, what happened during the crime and where are the evidences located to prove the case.

The key to this form of intelligence is predicting the future. The robot is able to predict the future (or the past) with pinpoint accuracy and extract relevant data from its future predictions. The relevant data from its future predictions will be activated in the robot's mind. This results in psychic abilities.

The intelligent pathways in memory were created in such a manner that the environment has little to do with the intelligence of the robot. If these intelligent pathways are string together in a continuous manner and matched to a realistic virtual environment, then we can actually trick the pathways into thinking that it has experienced these events. If the robot is given a task, he can “know” the outcome of this task by predicting the future.

The only problem I had was how to extract specific data from future predictions. I solved this problem by combining all the content in parent applications. The robot will use supervised learning to find patterns between a future prediction and the current pathway. Once the pattern is established the robot will know what specific data to extract from future predictions and activate that specific data in the robot's conscious.

Future predictions of the robot doesn't just apply to short-term pathways such as 5 minutes or 1 hour, but long-term pathways such as 2 weeks, 5 months, or even 300 years. Long tasks done by a human being or a group of human beings are done in fragmented sequences. For example, when a videogame such as Zelda is played the player doesn't just play the entire game continuously, but the player plays the game in fragmented sequences—they play the game for 2 hours one day, then the next day they play the game for 3 hours and they repeat this process until they past the game (which usually takes 1-2 months). The hard part was to extract specific types of data from long future predictions. I will be outlining this and other topics in this patent application.

### BRIEF DESCRIPTION OF THE DRAWINGS

For a more complete understanding of the present invention and for further advantages thereof, reference is now made to the following Description of the Preferred Embodiments taken in conjunction with the accompanying Drawings in which:

FIG. 1 is a software diagram illustrating the time machine.

FIG. 2 is a diagram depicting properties of a 3-dimensional environment.

FIGS. 3A-3B are diagrams depicting patterns in a videogame.

FIGS. 4-5B are diagrams illustrating brain activities in relation to human actions.

FIG. 6 is a diagram depicting the hierarchical levels of analyzing a human brain.

FIG. 7 is a diagram depicting the structure of the time machine.

FIGS. 8-13B are diagrams illustrating future prediction using hierarchical data analysis and pathway reconstruction.

FIGS. 14-17 are diagrams demonstrating future prediction using a time machine.

FIG. 18 is a diagram depicting future possibilities converging on most likely events.

FIGS. 19A-22 are diagrams depicting psychic abilities by extracting specific data from future pathways and activating said specific data in the AI program's mind.

FIGS. 23A-27 are diagrams depicting psychic abilities applied to the ABC block problem.

FIGS. 28A-30 are diagrams depicting psychic abilities applied to real world situations.

FIGS. 31A-32 are diagrams depicting psychic abilities applied to curing cancer.

FIGS. 33-36 are diagrams further illustrating psychic abilities applied to other real world situations.

FIGS. 37A-38 are diagrams illustrating open and hidden activation.

FIG. 39 is a diagram illustrating psychic abilities applied to a criminal investigation.

FIGS. 40A-40B are diagrams depicting merging of multiple pathways together.

FIG. 41 is a diagrams depicting letters being displayed in sequence order.

FIG. 42 is a diagram depicting different robots linked to the time machine storing and self-organizing pathways or experiences.

FIG. 43 is a diagram depicting a method of time travel.

FIGS. 44A-44B are diagrams illustrating the usage of patterns to extracting specific data from different types of pathways.

FIG. 45 is a diagram depicting intelligent robots in the time machine doing work.

FIGS. 46-47 are diagrams illustrating robots working together in the time machine to predict future pathways for the game of Chess.

FIGS. 48A-48B are diagrams depicting robots working together in the time machine to predict future pathways for a videogame.

FIG. 49 is a diagram depicting robots working together in the time machine to predict a future movie.

FIG. 50 is a diagram illustrating robots working together in the time machine to predict future events in real life.

FIGS. 51A-51D are diagrams illustrating prediction of universal pathways based on a human beings actions.

FIG. 52 is a diagram depicting the hierarchical structure of two brain models.

FIG. 53 is a diagram illustrating self-organization of human beings in a 3-d grid.

FIG. 54 is a diagram illustrating self-organization of work done by intelligent robots in a 3-d grid.

FIG. 55 is a software diagram illustrating a program for human level artificial intelligence according to an embodiment of the present invention.

### DESCRIPTION OF THE PREFERRED EMBODIMENTS

### The Time Machine

The time machine is an emulated virtual world of the real world. It is equivalent to the “computer generated dream world” in the Matrix movie or the “Holodeck” in Star Trek. All physical and non-physical properties are included in the time machine such as object mass, interactions, velocity, trajectory, chemical interactions, atomic structure and so forth. All objects, actions and events are stored as movie sequences in the time machine. The 2-d movie sequences will self-organize itself in such a manner that a 3-dimensional environment is created.

The purpose of the time machine is to match the robot's pathway to a pathway (or series of pathways) in the time machine. The pathways in the time machine serve as additional data to give the pathways in the robot a more realistic and accurate depiction of the real world. Data in pathways forget, so the robot is actually using pathways that are partially missing. It is the purpose of the time machine to fill in the missing pieces of forgotten pathways in the robot. For example, if the robot was in a room and he was walking backwards, the time machine will prevent the robot from walking through the wall that is behind him. The robot can't see the wall, so the robot isn't aware of the wall. The time machine creates a realistic environment so that when the robot's back touch the wall it will prevented the robot from going through the wall. This creates a more realistic and accurate depiction of the real world and the pathways in the time machine can interpret things that the robot is aware or not aware.

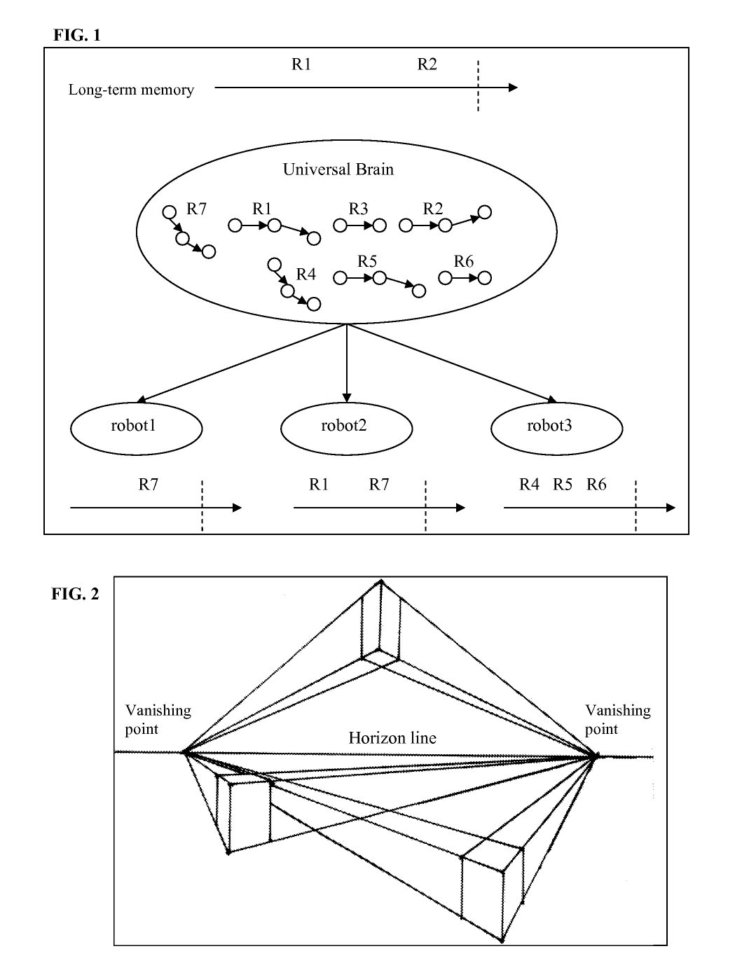

Referring to FIG. 1, the time machine comprises a universal brain that stores pathways from multiple robots living in the real world. There can be 3 robots or 8 million robots and all robots will be ranked according to a hierarchical structure. Each robot's importance will be judged by certain criterias, which are mentioned in parent applications. The more important a robot is the stronger their pathways are in the universal brain. There can also be cases where the priority of a robot can change depending on a situation.

The time machine has a more detailed environment of the real world than an individual robot's memory. Multiple robots are creating the pathways in the universal brain so the environment will have greater detail. For example, an individual robot might have a memory of a building, but the building is not detailed. In the universal brain the same building will have details such as the number of windows, words on the building, the exact color of the building, the texture of the building and so forth. As the robots see the environment, the 2-d pathways will form a 3-d environment of what they saw. Areas that all robots haven't seen will not be stored in the universal brain.

In addition to the creation of a 3-d environment, all facts and intelligent lessons from each robot is stored in the universal brain. Things that each robot experiences from the environment, wither its reading a book or learning language in school or practicing riding a bicycle, will be stored in the universal brain. All these pathways will self-organize itself based on priority. Each pathway will also forget data automatically so that the universal brain doesn't overload its storage capacity.

Each robot stores its own experiences in movie sequences—frame by frame. Each millisecond that passes the robot will store a snapshot of what it has sensed from the environment in terms of sight, sound, taste, touch and smell. The movie sequences are the data identified in the environment during a sequence of time. On the other hand, the “existence” of objects in our environment is also important. Two robots can experience the same events, but each robot can have slightly different interpretations. By experiencing the environment repeatedly the pathways can form universal pathways that will interpret the existence of an object/action/event and get rid of ambiguities. Language, as usual, is used to universalize pathways in memory and to organize data in memory.

Hidden Objects and Pattern Objects

Within the time machine are animate and inanimate objects that interact with each other. When an object or encapsulated objects move it creates hidden objects. When objects interact with each other hidden objects are also created. These hidden objects are stored in pathways to interpret Physic laws for one or more objects. In Physics, scientists use math equations to interpret the movement of an object. Things like acceleration of an object is derived from mass, gravity and force of that object. In the time machine, Physic laws are created by observation of an object; and the sequential state of the object in a movie sequence. When someone drops a ball to the ground the movie sequence of the ball falling to the ground will create hidden objects. By averaging similar objects falling to the ground, their hidden objects will create a universal pathway to interpret the most likely probability of an object falling to the ground. The math equation of any object falling to the ground is embedded as a hidden object in a universal pathway.

The 3-d environment in the time machine will not only have an accurate emulation of physical objects in the real world, but also, object properties such as mass, texture, movement, interactions, and action. All this is learned by observing objects and how it behaves in movie sequences. The movie sequences depict what the object will do in sequential order. The job of the robot is to predict what it will do in the future. Predicting the actions of an inanimate object is easy because it doesn't move. However, predicting the actions of an animate object is harder. A tree is an animate object and its' movements depend on the wind. There are also intelligent animate objects such as animals and human beings. Predicting their actions in the future will be even harder.

In the next couple of examples I will outline some hidden objects in the time machine. A math equation for gravity is easy for the AI program to find, but what about math equations for the movement of birds or math equations for driving a car? I will be giving examples of math equations of simple objects first, then I will give examples of math equations for complex objects. Objects in this case can be anything—it can be a group of objects, actions or events. Pathways store objects, actions or events in a sequential manner.

Videogame equations—In a videogame there are math equations that govern the environment. These math equations set the rules of how objects interact with one another. The time machine will find all these math equations and store them in their respective pathways. Equations can be found by observing how objects interact with one another. When a player moves the environment moves with it. The vanishing point will be found because inanimate objects move in a fixed manner in relations to the vanishing point (FIG. 2). On the other hand, inanimate objects move so the inanimate object in relation to the vanishing point will be different. The horizon line is also an object that will be found.

Other things like gravity are found by observing people jump or observing falling objects. The mass of an object matters in relations to gravity; and mass of an object will be determined by the 3-d images of that object (including eye distance). For example, a car has mass and most cars weigh the same. The different type of cars will classify different masses. However, what if the car was looked at in a picture? Because the eye distance of a car in a picture looks different from the eye distance of the real car, then the mass of the picture of the car is different from the mass of the real car.

In a videogame, math equations of the player can be derived. For example, if the robot was playing a first-person shooting game like Contra, he will notice that there is an equation to the way the player moves in the game. If the player moves in the middle of the screen, the camera moves to the right or left. If the player moves anywhere besides the middle of the screen the camera doesn't move. With this observation the AI program should derive a math equation for the movement of the player in relations to the screen.

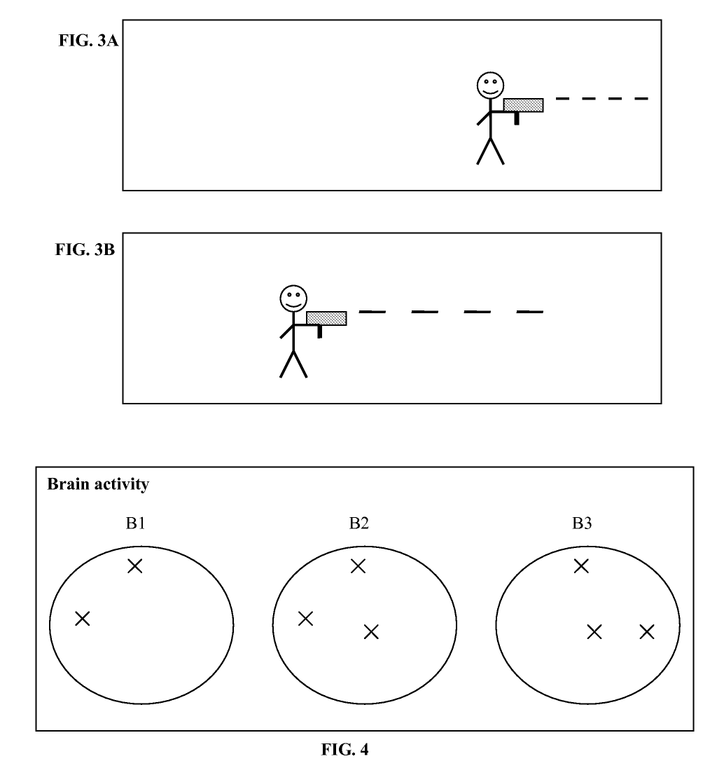

When the player fires his weapon the speed of the bullets shoot out in relations to the location of the player. Referring to FIG. 3A, if the player is very close to the right screen then the bullets will shoot out quickly. Referring to FIG. 3B, if the player is farther a way from the right screen then the bullets will shoot out slowly. With this observation, the AI program should derive a math equation for the firing of bullets in relations to the position of the player in the screen.

This math equation of the firing of bullets by the player is important because the AI program can predict what the firing of bullets will look like regardless of the player's position on the screen. For example, if all pathways in memory are trained with the player on the bottom-half of the screen, but there are no pathways with the player at the top-half of the screen, then if the current game has the player on the top-half of the screen the AI program can use the math equation to predict how the player will fire bullets—how fast the bullets will fire in relations to the position of the player on the screen.

Predicting Animate and Inanimate Objects

The robot has to predict the outcome of all objects in the real world. This would include animate and inanimate objects. Here is the list of inanimate and animate objects:

1. inanimate objects—buildings, rocks, roads, bridges, books, furniture, computer, houses, mountains and so forth.
2. animate objects (simple)—trees, traffic lights, water, shirt, silk, cars, planes, clouds, billboards, simple machines, and so forth
3. animate objects (complex)—animals, insects, humans, software, complex machines and so forth.

Predicting the future state of an inanimate object is relatively easy. The object stays in one area and rarely moves, unless another object moves it. The robot records the object in pathways and it might appear like that object is moving, but it's actually the robot's eyes that are moving. A simple equation can be computed to calculate an inanimate object and what it will look like in the future.

Predicting the future state of an animate object such as an insect or animal is more difficult because each object relies on a brain in order to take action. These animate objects use instincts or simple intelligence to take action. If the robot can analyze the brain structure of the object it can predict what the probable action that object will take in the future.

Another problem is that sometimes intelligent objects such as insects and animals rely on instincts instead of intelligence to take action. Birds do not have a fixed way to move. Most of its actions are based on instincts, wherein it uses its 5 senses to detect food in its environment. A bird's probable future state can be calculated by a math equation and not by analyzing every pathway in its' brain. Instincts can also be known as random actions and doesn't really depend on what the environment is. Another way to predict the actions of an insect or animal is to lock onto certain foods around that animal or insect and find a pattern between the actions of the insect or animal and the food.

Finding Patterns in a Human Brain in Relations to the Human Beings Future Actions

It is much harder to predict the actions of a human being because the possibilities are endless. If I had to predict the actions of a human being, I would have to predict what he/she is going to say, how he/she will behave, or what physical actions he/she will take. This task would seem impossible. The actions of a human being are directly linked to a human being's brain. By analyzing the brain and observing the future actions of the human being we can form patterns that will tell us what a human being will do.

There are two methods to analyze the brain: (1) external scanners (2) enhanced robot senses. An external scanner can be built to analyze the brain and teachers can teach the robot how to relate the brain activity of a human being to his/her actions. The scanner can gather very complex brain activities and sort out the data to be presented to the robot in a very simple way. This data from the brain is then used to associate future actions of a human being.

The second way of analyzing a human being's brain to his/her actions is by enhancing the robot's senses (most notably the sense of sight). The robot's vision has a focus area and peripheral area. The area that the robot is focusing on is clear while the peripheral vision is blurry. To enhance the sense of sight for the robot, the images in each frame has to be 3-dimensional. This means the robot can not only see an object from the outside, but also from the inside. The focus area can also be enhanced to zoom in on smaller areas such as focusing on a single atom inside a 3-d object.

There are levels of brain scan, a simple scan of the brain will include electrical outputs of the brain. The intensity of the electrical output, the configuration of electrical output and the interaction of electrical output are recorded. The robot will observe these three types of data and find patterns between the brain activity and the human beings' future actions.

Referring to FIGS. 4, B1 B2 and B3 are movie sequences recorded from observing the activities in a brain. New electrical outputs are recorded, while electrical outputs that disappear are not recorded. The intensity of each electrical output is also recorded as well as each electrical outputs' location in the brain.

Teachers will teach the robot to observe and to focus on specific areas of the brain using sentences. Sentences such as: “look at the configuration of the electrical outputs and find any patterns”, “take a look at the brain's left-top hemisphere”, “observe the intensity of the electrical outputs”, “compare the patterns found in the brain activity to the human being's future actions”. By using logical analysis of brain activity and comparing that to the human being's future actions the robot can find patterns faster.

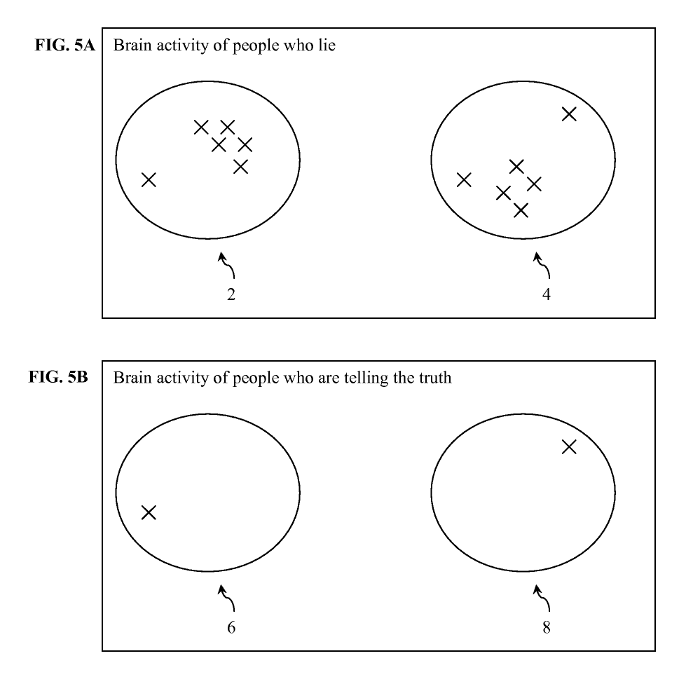

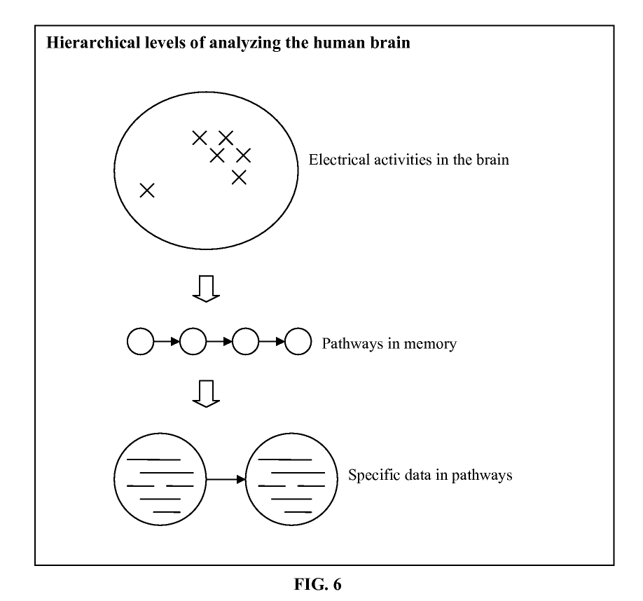

Many similar pathways in memory will be compared and a universal pathway will result. Referring to FIG. 5A-5B, in terms of analyzing the brain, when a person is lying there are multiple areas in the brain that is active (pointer 2 and 4). When a person is telling the truth only a small area in the brain is active (pointer 6 and 8). Teachers will teach the robot these lessons and the robot will be able to analyze a person and determine wither he/she is lying or telling the truth.

A more advance scan of the brain will include scanning each pathway in memory and scanning every data in each pathway. This would be a very difficult task because every atom of a pathway has to be scanned and stored in memory in movie sequences. Having the ability to find patterns in such a large amount of information is also an issue. More data in the pathways mean longer time for the robot to find patterns. Referring to FIG. 6, the comparing of data to find patterns will be done in a hierarchical manner, wherein a method of observing the brain is done by focusing on simple electrical outputs, then focusing on each pathway in the electrical output and finally focusing on specific data in each pathway.

Frontier Research

Scanning a human brain is a difficult job, but scanning complex software is even harder. If the robot had to predict the actions of an operating system is it possible to predict the exact functions? The human brain controls a human being and by observing the brain the human beings' actions can be predicted. A piece of software on the other hand is harder to predict because the robot has to scan the entire computer including all computer chips, the CPU, the software installed, the transistors and so forth. A snapshot of all components that make up the computer has to be stored in each frame in the movie sequence.

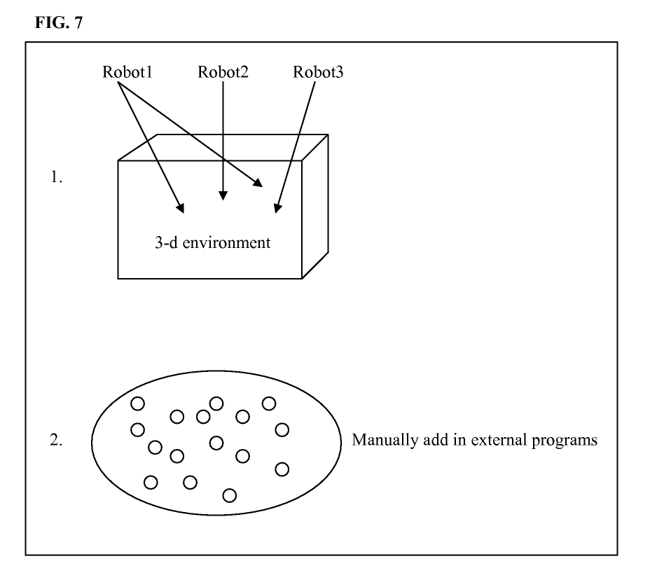

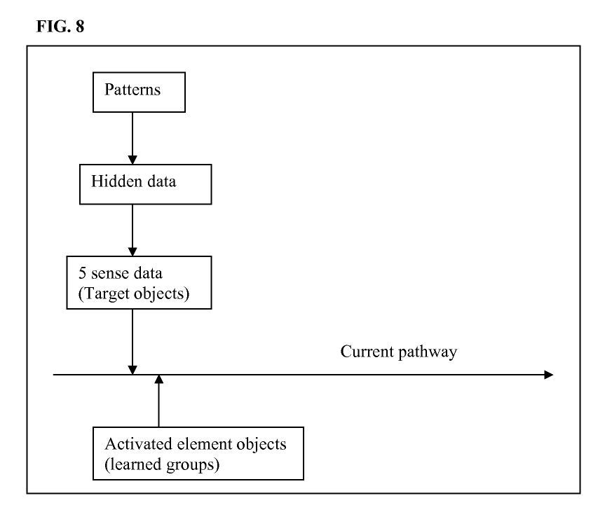

The task of scanning all atoms from a computer is crucial; and knowing what to focus on at specific times during the operating system's actions is crucial. This subject matter is very difficult to solve and I think in the future someone might find an efficient way to solve this problem. In the time machine all objects are learned through observation, but I also included additional features. These features include adding in software to objects such as computers, machinery, the internet, and anything that requires embedded computer chips. The internal wires that control a machine are also included. This will make machines such as cars, planes, forklifts and skyscrapers more realistic. FIG. 7 depicts the structure of the time machine. 1. multiple robots create the pathways in the time machine. In turn, the 2-d pathways create a 3-dimensional environment. 2. manually inserting external programs such as the internet, computer codes, software, computer chips and wirings and machinery.

Universal Time Machine

The time machine not only has to create a 3-d environment from 2-d movie sequences of our environment, but “any environment”. If life is an Atari game and consists of 2-d objects then the time machine has to record all data from this environment. The hidden objects within this Atari game are also recorded in the time machine. The way objects in the game moves and interact with each other will be recorded in the time machine.

A universal type of time machine must be created where the robots learn, not only the environment of the real world, but also the environments of other worlds such as a videogame. If life changes and the things we see are totally different we have to reconstruct the pathways in memory to adapt to the current environment. If gravity is decreased by 40% then we have to reflect that hidden object in the time machine. If we drop a ball to the ground, but the ball floats to the sky, then the time machine has to also store that data in memory. If people turn into cartoon characters, then these experiences will be stored in memory.

Self-organization will bring environments that have common traits closer to one another. The environments self-organize itself based on commonality groups (5 sense data, hidden data or patterns) and learned groups (sentences or meaning to sentences). The end result is a universal environment that all intelligent robots have learned. The time machine will simply take pathways from a robot and match it to the closest pathway in the universal brain.

Predicting the Future

Predicting the future requires the AI program to string continuous pathways in memory together (called future pathways). The job of the AI program is to determine which future pathway will most likely occur in a hierarchical manner, wherein future pathways are ranked based on the most accurate future prediction and most detailed future prediction.

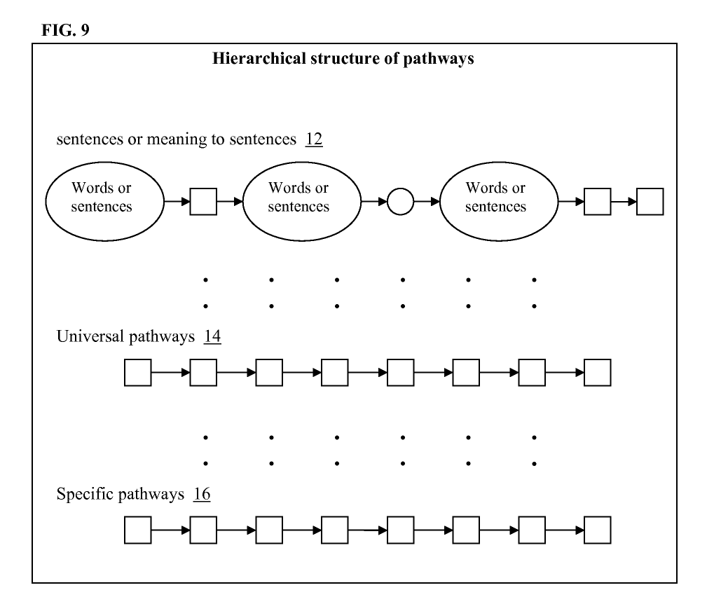

Referring to FIG. 8, in a given pathway there are 4 different data types: 5 sense objects, hidden objects, activated element objects and pattern objects. The AI program dissects the objects in the current pathway into sections of data called partial data based on an initial encapsulated tree and an optimal encapsulated tree.

Pathways in memory are structured in a hierarchical manner wherein the most important objects in a pathway floats to the top-levels and the least important objects (noise) floats to the bottom-levels. Referring to FIG. 9, the top-level (pointer 12) is the conscious thoughts of the robot. The conscious thoughts of the robot is usually represented by sentences or meaning to sentences. The reason why words and sentences are the most dominant data in memory is because language encapsulates entire objects, actions or events. The existence of objects, actions or events can be referenced by a fixed word or sentence. For example, the words “put on a jacket” can encapsulate any movie sequence that has a person putting on a jacket. The robot observing the scene can be positioned in any angle, the person who is putting on the jacket can be a man, women, child, or even an animal, and the color and shape of the jacket can be anything. The words “put on a jacket” encapsulate entire scenes in a movie sequence.

In the middle-levels of the hierarchical tree are universal pathways (pointer 14). The average data that is created in memory based on the average of similar pathways are called universal pathways. Universal pathways can also be considered minus layer pathways because if 2 or more pathways share sections of data, said section of data becomes stronger.

In the lowest-level are the specific 5 sense pathways (pointer 16). These are specific data sensed from the environment from the robot's 5 senses: sight, sound, taste, touch and smell.

There are no clear cut lines between the data in the hierarchical tree. The top-level pathways (pointer 12) don't exclusively consist of sequences of words or sentences, they can be individual images, or a sound or a group of sequential 5 sense data. Pathways in the hierarchical tree can mix sequences of the 4 different data types: 5 sense objects, hidden objects, activated element objects or pattern objects. The AI program will determine what data in pathways are strong and what data in pathways are weak by self-organization. The end result is a 3-dimensional grid with multiple data structured trees organized in a hierarchical manner.

How Future Pathways are Fabricated

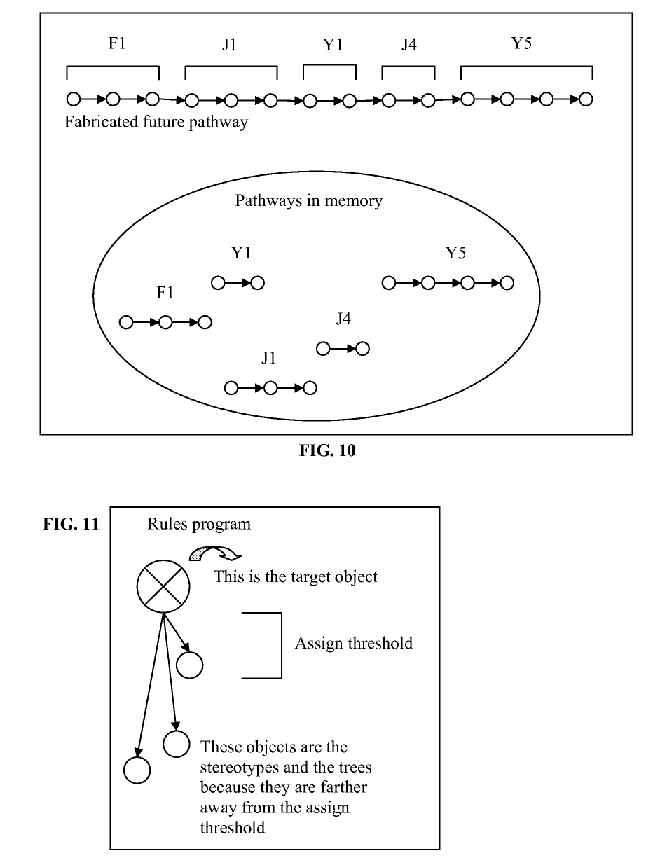

From each state in a future pathway the AI program has to fabricate the most likely continuation. The longer and more accurate a future pathway is the better the future prediction. FIG. 10 shows a diagram of a long future pathway fabricated by taking continuous pathways in memory.

Steps to Predict the Future (a Summary)

1. predict future pathways by using hierarchical data analysis.
2. predict future pathways by using linear and universal pathways.
3. predict future pathways by reconstructing forgotten pathways.
4. predict future pathways by using external reconstructive programs.
5. predict future pathways by using a time machine.
6. predict future pathways by using logical learning.

The 6 steps mentioned above are used in combinations to come up with future pathways. They work together in combinations so that future pathways are accurate and realistic to what will eventually happen in the future. All 6 steps have been discussed in parent applications (most notably patent application: 61/035,645 and patent application: 61/028,885). This patent application will mainly focus on the 5^{th} step which is: predict future pathways by using a time machine.

Reconstructing Forgotten Pathways

Because data in pathways forget information the AI program has to reconstruct what the original pathway was when it was first stored in memory. All 4 different data types have to be reconstructed. If the optimal pathway matched in memory is a minus layer pathway then the AI program has to reconstruct the minus layer pathway as it was when it was first stored in memory.

Reconstructing a picture or movie sequence (5 sense objects) from a forgotten pathway requires the AI program to search in memory for a close match. Most data in pathways have multiple copies in memory—some of these copies are clear while other copies are fuzzy. All objects belong to a floater and the floater contains a hierarchical structure of that object in a fuzzy range. By searching for same copies in memory the AI program can reconstruct what the original picture or movie sequence was.

Reconstructing hidden objects and pattern objects work the same way. The AI program has to search for multiple copies in memory and tap into that objects floater (the floater contains a fuzzy range of that object). From there, the AI program can try to guess what the original hidden objects or pattern objects were.

Reconstructing activated element objects is a little tricky because there are levels of activated element objects. Referring to FIG. 11, the target object is the object that the AI program recognizes from the environment. The AI program will activate the strongest element object associated with the target object. The closer certain element objects are to the target object the more likely it will be activated. There are three types of element objects: equal, stereotypes, and trees. Any element object that passes the assign threshold is considered equal to the target object. The stereotypes are element objects that have association but are not consistent. Stereotypes would include things like facts, knowledge or related objects to the target object. Trees are element objects that have consistent timing with the target object. Usually sentences said at certain times in a pathway are considered trees. The closer the timing of the target object and the trees is the more association it has with each other.

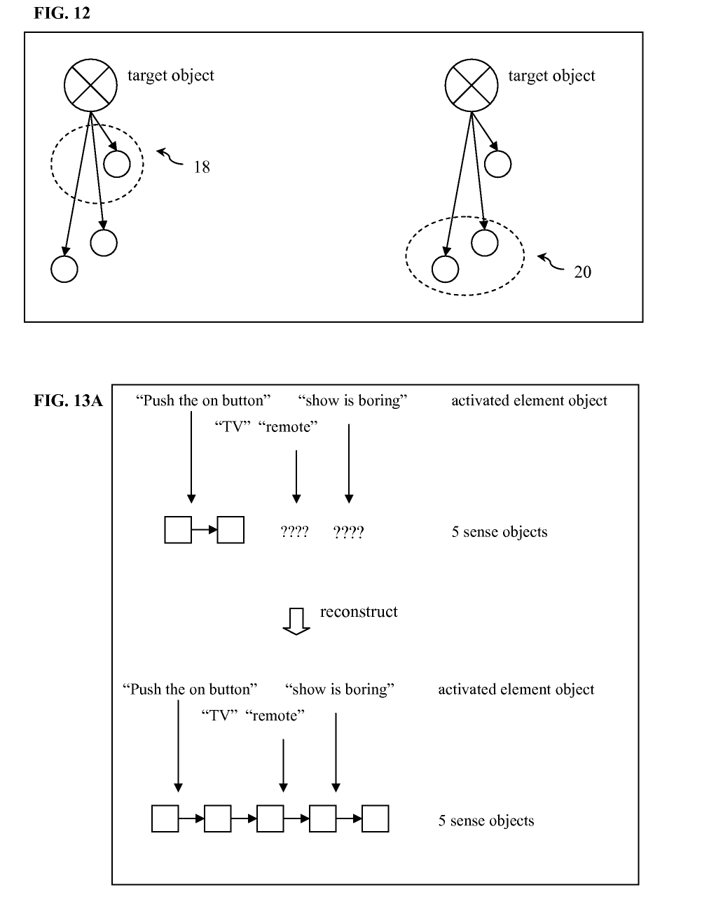

Referring to FIG. 12, imagine that a forgotten pathway forgets the meaning to a target object. The AI program has to reconstruct what the meaning is and when that element object was activated. If the forgotten pathway forgets the stereotype to a target object it has to reconstruct what that stereotype is. It is easier to reconstruct the meaning to a target object than reconstruct the stereotype to a target object. The meaning to a target object is consistent so it's easier to guess what the meaning is (pointer 18). On the other hand, the stereotype to a target object changes so its harder to guess what the stereotype is (pointer 20). Facts and knowledge about an object changes as the robot learns from its environment.

To complicate things even more certain element objects are activated by multiple target objects. This would mean that in order to reconstruct a forgotten activated element object in a pathway, the AI program has to guess what target objects activated the element object. Logical thoughts are usually activated by multiple target objects. It is very difficult to predict the conscious thoughts of the robot in the future. As long as that conscious thought is consistent and is repeating then it can be predicted.

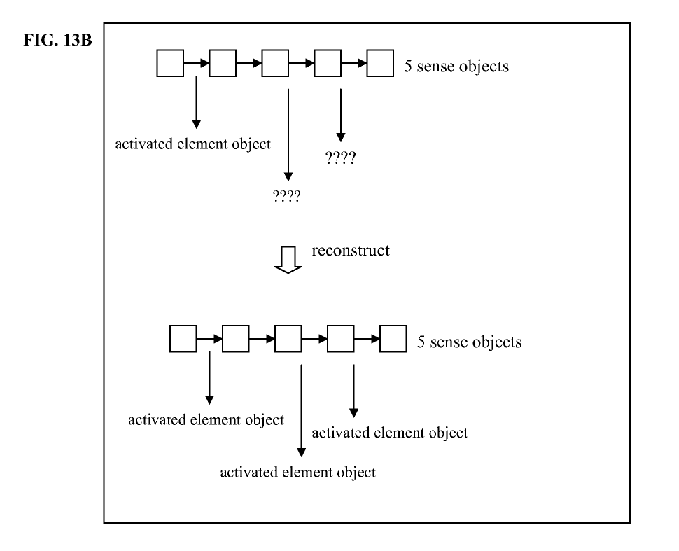

The activated element objects are the conscious thoughts of the robot and in order to predict the future with pinpoint accuracy the AI program has to predict what the robot will be thinking of in the future. All 4 different data types will be reconstructed in the future pathway in a hierarchical manner, wherein the most important objects are reconstructed first before the least important objects are reconstructed. The diagram in FIG. 9 shows the hierarchical structure of pathways. Usually words and sentences represent entire situations and objects. Referring to FIG. 13A, the AI program will use these words and sentences and the remaining pictures or movie sequences to reconstruct the original 5 sense data from the environment. Referring to FIG. 13B, on the flip side, forgotten pictures or movie sequences will be used to reconstruct the original activated element objects (conscious thoughts of the robot).

Conscious Thoughts of Individual Robots

As the robot learns more and more from the environment the pathways in memory become more complex. These complex pathways will eventually form the robot's conscious. Referring to FIG. 9, the majority of the conscious comprises words and sentences to guide the robot to: plan tasks, solve interruption of tasks, predict the future, give information about an object, provide meaning to language and so forth. At this point the pathways in memory are intelligent; and are capable of guiding the robot to take the correct action in the future regardless of what the environment is. The robot is also able to adapt to the environment if it does change.

If the robot loses the sense of sight, the robot's conscious will still be able to come up with logical conclusions or brainstorm ideas. The other 4 senses can be used to learn new lessons from the environment. If the robot loses the sense of sound, the robot's conscious will still be able to use sight to learn things and use sign language to communicate with other people. Once the conscious is formed the environment is of little concern to the robot. What matters is not what is experienced from the environment (the 5 sense objects), but using the robot's conscious to make itself better in the future. The robot will pursue pathways that lead to pleasure and to stay away from pathways that lead to pain.

One example is a baseball game. If the robot was playing a baseball game the 5 senses coming from the batter, the catcher and the umpire are very similar. However, each person has their own role and objective in the game. The batter has to hit the ball, the catcher has to catch the ball and the umpire has to determine the type of ball pitch. The conscious will tell the robot that he is playing the role of the batter or the role of the catcher or the role of the umpire. By following intelligent pathways the robot knows what it has to do regardless of the environment.

Once the robot's conscious is built it is intelligent and it can adapt to its environment. If the robot lives in Mars or if the world is upside down or if the robot lives in a 2-dimensional world, the pathways in memory will allow the robot to adapt. Adapting in this case is adapting the intelligent pathways in memory to the current environment. If the intelligent robot is living in a simple virtual world the robot can still use its conscious to work and solve complex problems. In fact, the robot doesn't need any environment to do reasoning or to brainstorm. The robot can simply close his eyes and come up with new ideas and new ways of solving a problem.

However, a simple virtual world is needed because the robot has to write down its ideas on a notebook or read the ideas from the notebook. Writing down sentences and drawing diagrams will greatly help in brainstorming new ideas or solving problems. Things that the robot has written down can be stored in the notebook and the robot can recall these ideas, not from memory, but from rereading the notebook. Also, sequence logic is crucial because in order to solve a complex math problem all the calculations has to be written on paper. The robot has to see these calculations during runtime in order to solve the complex problem.

Predicting the Future Using a Time Machine

After the AI program fabricate future pathways hierarchically and reconstruct the future pathways, the AI program will match each future pathway to the pathways in the time machine. The time machine is used to give the future pathways a more accurate and realistic prediction. Since the time machine is a collection of pathways from multiple robots, the pathways are no doubt more accurate and detailed.

The time machine contains a 3-dimensional environment that emulates physical and non-physical properties in the real world. The 4 different data types: 5 sense objects, activated element objects, hidden objects and pattern objects will create a realistic environment that has objects that interact with each other based on physic laws and properties.

The steps to predict the future using a time machine comprises: 1. matching each dominant future pathway to sections of pathways in the time machine. 2. providing predicted results for each state in a future pathway in a hierarchical manner. Predicted results will be given to the closest state to the current pathway first. 3. Outputting multiple specific future pathways. Each specific future pathway will be detailed, comprising 4 different data types: 5 sense objects, hidden objects, activated element objects and pattern objects. Every frame in each specific future pathway is constructed in detail and should match with events that will occur in the future. In some cases like driving a car in unfamiliar roads or solving an unknown math problem, specific future pathways contain a combination of linear or universal pathways.

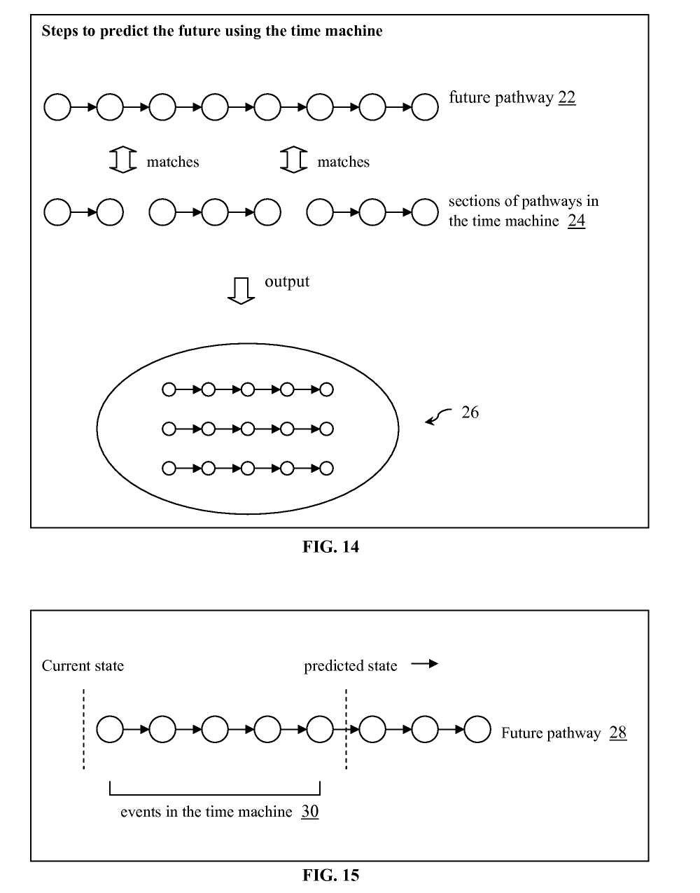

Referring to FIG. 14, this diagram depicts how the time machine is used to predict the future. First, a future pathway 22 is used. Future pathway 22 is fabricated hierarchically from the robot's memory and reconstructed from forgotten data. Next, sections of pathways 24 in the time machine are matched to future pathway 22. Finally, after creating predicted results for each state in future pathway 22, multiple specific future pathways 26 are outputted. Each specific future pathway is derived from future pathway 22. The time machine serves its purpose by making the future pathway more “specific”. Each specific future pathway will also have to recalculate its pathway worth and re-ranked.

How Specific Future Pathways are Created

Referring to FIG. 15, for each future pathway there exist a predicted state. The predicted state is a pointer that travels from the beginning of the future pathway to the end of the future pathway. It tricks the future pathway into thinking certain events have occurred. All events 30 that fall between the current state and the predicted state are considered experiences in the time machine and the robot (for that future pathway 28) will think these events 30 happened.

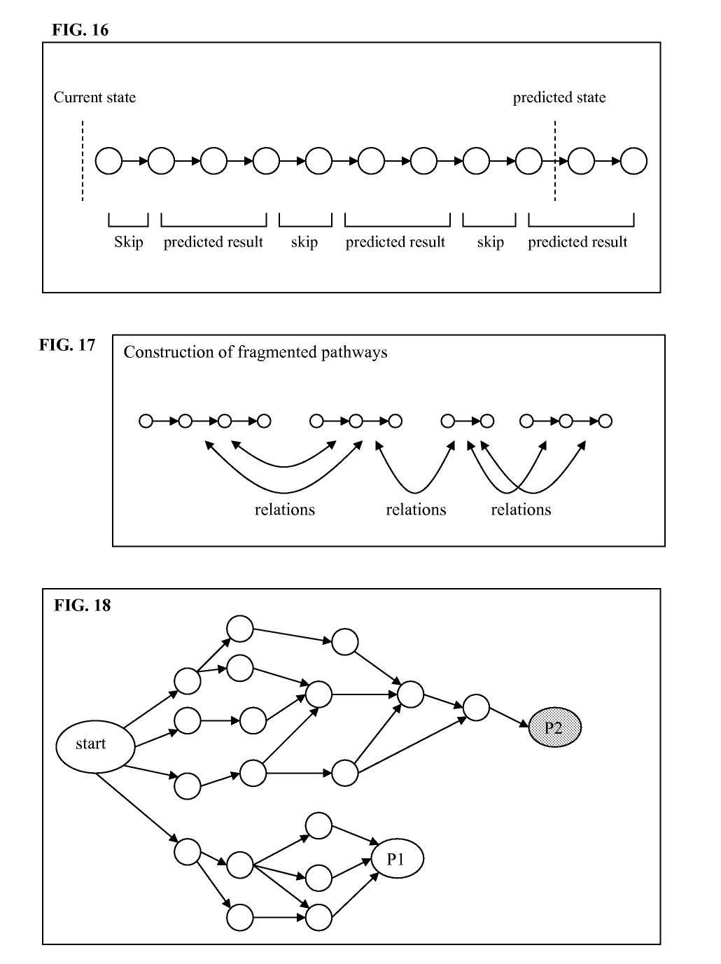

Events that have occurred will be known as predicted results. The AI program will predict the future hierarchically, wherein the most important events are predicted first. Because certain events in the future can't be predicted the time machine will give predicted results to certain events closest to the current state. Unpredictable events will be skipped (FIG. 16). These unpredictable events will either have a universal pathway or logical intelligence to cater to infinite possibilities. Some of these unpredictable events would require data from the environment in order to predict. For example, if the robot had to predict a math equation that a teacher will give, the robot will not be able to predict the exact math equation. The math equation can be anything. If the robot can't predict the math equation, then the robot can't predict the solving of the math equation. Another example would be to predict the frame-by-frame data from an unknown movie. If the robot hasn't seen this unknown movie before, it is not possible to predict what will happen in the movie. This is why unpredictable events will be skipped by the time machine. The predicted results will only occur after certain information is sensed from the environment.

Referring to FIG. 14, the time machine will also correct some pathways in future pathway 22. There are things in the pathway that the robot is not aware of—the wall that the robot doesn't see behind it or the ant that is crawling on the floor or the table that the robot is not aware of. The 3-dimensional environment in the time machine provide a more realistic and accurate depiction of future pathways. Not just in terms of physical objects in the environment but physic laws like gravity, object interaction, acceleration, object mass, atomic structure and chemical reactions. If the robot uses a pathway in memory which depicts a room, the time machine will represent the room in a 3-d manner. If the robot hits a wall the time machine will express this, if the robot bumps into a chair the time machine will express this, if the robot puts a book on a table and returns 5 minutes later the book should be on the table.

Extra note: The time machine records all data from the robot's vision and stores them as atoms in the 3-dimensional environment. For example, if the robot was given a long equation on the blackboard by a teacher, all the robot needs to do is look at the equation with a glance. The entire blackboard and all of its atomic structure is recorded in the virtual world (the time machine). The robot doesn't need to focus on each number or each diagram on the blackboard. Even images from the robot's peripheral vision will be recorded in the time machine. At this point the robot can analyze the equation in the time machine. He can predict the future of how to solve this math equation.

The robot can also read an entire book once and all content in the book will be recorded in the time machine. This would include all text, diagrams, pictures and so forth. The entire book is physically created in the time machine. Even a cursory glance of all the pages is enough to store all content in the book. If certain pages are read the time machine will only have pages that were seen by the robot. If the same book was read by another robot linked to the time machine, then the book exist in the time machine and the robot doesn't have to even look at the book.

If certain pages of a math book were read, then the robot doesn't have to reread the same pages in the real world because there exists an exact copy in the time machine. The robot can predict the solving of math assignments in the time machine. Rereading of the math book will be done in the time machine and not in the real world.

Constructing Long Future Pathways

Future predictions of the robot doesn't just apply to short-term pathways such as 5 minutes or 1 hour, but long-term pathways such as 2 weeks, 5 months, or even 300 years. Long tasks done by a human being or a group of human beings are done in fragmented sequences. For example, when a videogame such as Zelda is played the player doesn't just play the entire game continuously, but the player plays the game in fragmented sequences—they play the game for 2 hours one day, then the next day they play the game for 3 hours and they repeat this until they past the game (which usually takes 1-2 months). The hard part was finding a way to extract specific types of data from long future predictions. I will be outlining this and other topics in the next section.

Referring to FIG. 17, future pathways are constructed from fragmented pathways in memory. The most likely continuation of a pathway will be stringed together forming a long future pathway. The key to continuous pathways is the relations the ending part of a pathway has with a beginning part of another pathway. The closer two pathways are to each other the more likely they are continuous. Pathways in memory grow longer with more training. Sometimes they break apart into a plurality of sub-pathways when data is forgotten.

The AI program has to know what the “noise” are in continuous pathways. If the robot was playing a videogame and the robot needed to get something to eat, the task of getting something to eat is considered a “noise”. In terms of the Zelda game, the AI program will string together all the pathways that relate to playing the game (in linear order). Level1 is fabricated first, then level2, then level3, then level4 and so forth. If it took the robot 2 months to past the game, then it has to string together 2 months worth of playing the game. The continuation of the pathways to play the Zelda game relies on relations. This will filter out all the “noise” such as eating, taking a break, sleeping, bathing and other unrelated tasks.

Even ideas that pop up in the robot's mind are considered fragmented pathways. If the robot is in a bus riding to work and he is brainstorming a way to past the 3^{rd} level in the Zelda game, then that pathway will be part of a future pathway because it has relations with the task of playing the Zelda game. Self-organization and repeated training will help in determining which pathways are continuous and which aren't.

Relations and patterns can also indicate where a future pathway ends. If a task is to find a solution to a problem, patterns can be found so that the ending of the future pathway will result in finding the solution to the problem. In terms of the ABC block problem, the future pathway can end when the task of stacking up the blocks in an ABC format is met. The goals of any task can be found by patterns or by repeated training. This can put a limit to how long a future pathway can be.

Conscious Thoughts to do Work

If the robot had to do the same task 100 times, each task will yield a different result. Drawing a picture of a cat, for example, would require the robot to draw 100 pictures and in each picture the outcome is different. If the robot was instructed to write the same book 100 times the content and chapters of each book will be similar, but the exact words and paragraph structure will be different. For all tasks there can exist infinite results.

The idea behind the human robot is to use intelligent pathways in memory and trick the pathways into thinking certain events has occurred (by using the time machine). The end result is intelligent work done by the robot.

When the robot predict one future pathway accurately and realistically, then all work done by the future pathway is automatically stored in the time machine. If the robot predicts the task of drawing a picture of a cat, then the end result is a cat picture stored in the time machine. If the robot predicts the task of writing a book, then the end result is a book stored in the time machine. As mentioned before, there are infinite ways to accomplish a task. The future pathways predicted by the robot should be dominant pathways of accomplishing a task. This means if there exist 20,000 ways of drawing a picture of a cat, the robot will predict the most dominant pathways to draw a cat—predict future pathways that have the highest worth. Each future pathway of drawing a cat may not be exactly alike, but they should be similar.

Curing cancer is another task that might yield very different results. Imagine that there exist 3 ways of curing cancer. The robot may actually predict 2 cures for cancer. Referring to FIG. 18, P2 has 6 future pathways that lead to the same cure. Although each future pathway is different in terms of leading to P2, the end result is the same or similar. Out of the 6 different ways of getting to P2 the robot will pick the strongest future pathway. In fact, all future pathways are ranked based on their worth and the robot will pick the future pathway with the strongest worth.

Robots with Psychic Abilities

The present invention allows a robot to have psychic abilities. The robot's psychic abilities have several steps. First, the robot predicts the future. Then, it will extract specific data from future pathways and insert them as element objects in the robot's conscious. From previous patent applications, the conscious works by: recognizing target objects from the environment and gathering all element objects associated with each target object. All element objects gathered from all target objects will compete with one another to be activated in the mind.

In addition to the element objects from the target objects recognized, the AI program will insert future element objects from predicted future pathways. These future element objects will compete with ordinary element objects and the strongest element object/s will activate.

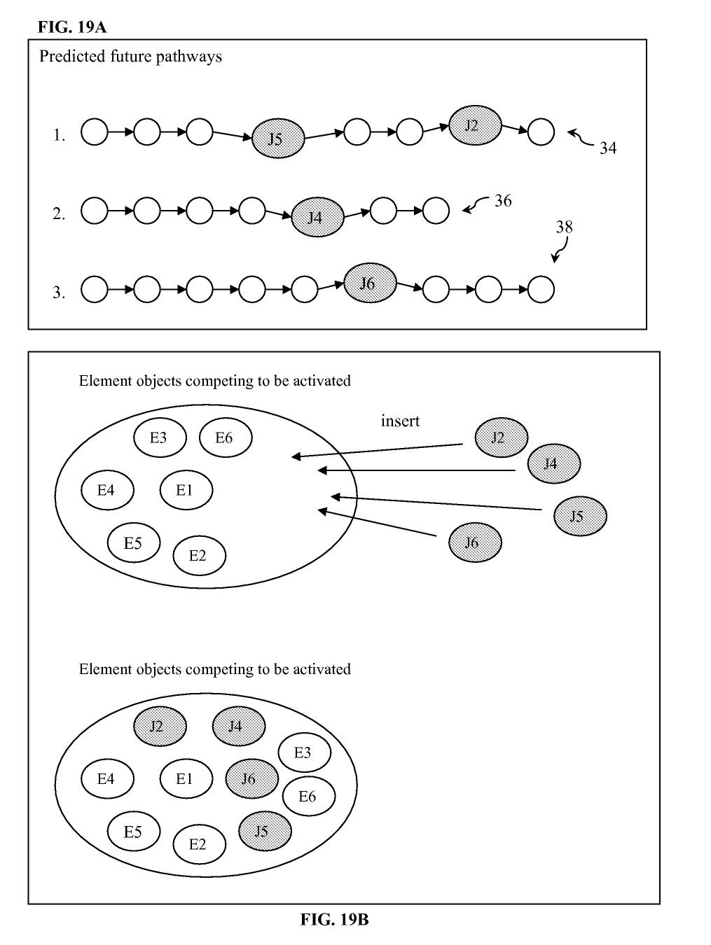

FIG. 19A is a diagram depicting 3 future pathways. Future element object J2, J4, J5 and J6 are extracted from the future pathways. J2, J4, J5 and J6 are strong future element objects. In FIG. 19B, future element objects J2, J4, J5 and J6 are inserted into the conscious and they will compete with all the other element objects to be activated.

The higher the ranking the more likely a future element object will be selected to be inserted into the conscious. Referring to FIG. 19A, in future pathway 34, future element objects J5 and J2 was extracted. In future pathway 36, future element object J4 was extracted. And in future pathway 38, future element object J6 was extracted.

I call this form of intelligence “psychic” because the robot, now, has the ability to activate events that will happen in the future. Not just short-term future events, but long-term future events. These activated events can be in the form of words or sentences or images or movie sequences or sound or a combination of the 4 different data types. If the robot is solving a crime it will activate data that it will presumably gather in the future based on the robot's research. Facts that will eventually be gathered will include: the identity of the suspect, the time-line of the crime, the location of the weapon used in the crime and so forth. The next couple of sections will describe how certain facts from future pathways are gathered.

Supervised and Unsupervised Learning

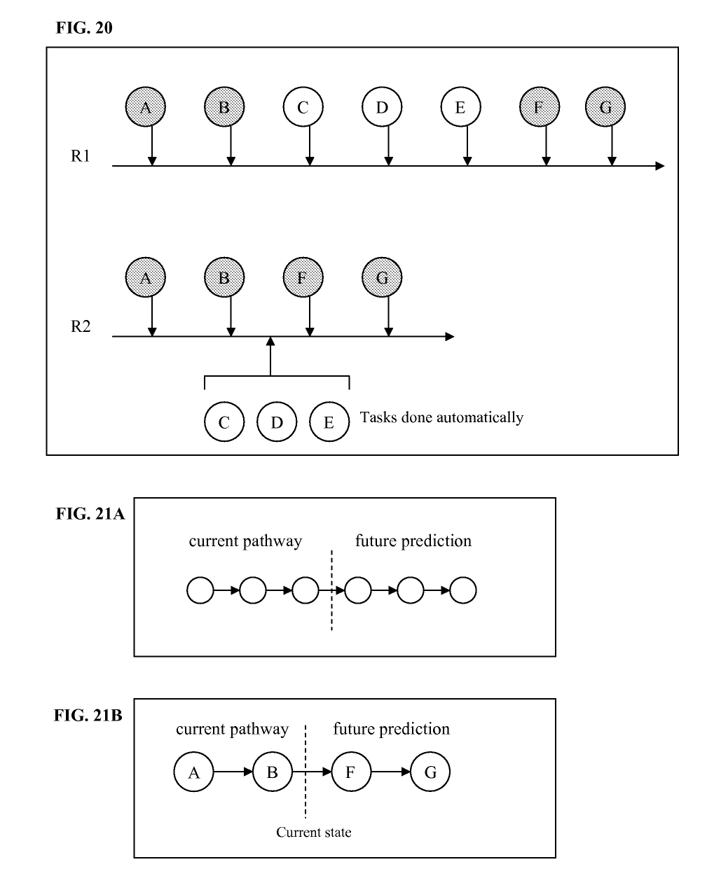

Pathways in memory get stronger and stronger from repeated learning. Strong pathways have an easier time finding patterns between other strong pathways. Referring to FIG. 20, if pathway R1 establishes patterns with pathway R2, clearly there are relations between the two pathways. Letters A-G represents tasks in a pathway. Tasks A, B, F and G are the patterns between pathway R1 and pathway R2.

Pathway R2 is considered a supervised learning by a teacher because tasks F and G are the tasks we want the robot to do after tasks A and B are encountered. A teacher wants to give the robot clues as to what the robot should do after task A and B are encountered. The teacher wants tasks C, D and E to be done automatically by the robot.

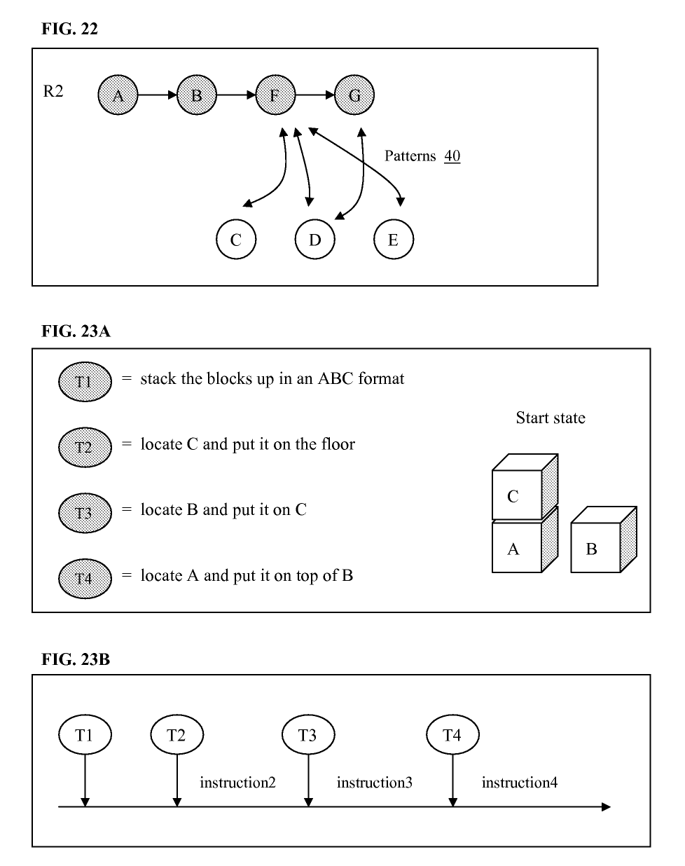

Referring to FIG. 22, imagine that in order for tasks F and G to exist, tasks CDE has to be done first. This will establish patterns 40 between tasks FG to tasks CDE. The stronger the patterns between two pathways (section of pathways) the more likely they are associated in some way. Referring to FIG. 21A-B, this behavior will ultimately create pathway R2, wherein when tasks AB are recognized by the robot, tasks CDE are done automatically and tasks FG will be the robot's next action.

If pathway R1 and pathway R2 is compared with similar pathways to R1 and R2, then a universal pathway will result. Since there are patterns between similar examples the patterns between R1 and R2 gets even stronger. At this point, when tasks A and B are encountered by the robot, tasks CDE are done automatically, and tasks F and G are tasks the robot will do in the future. When pattern 40 is created, pathway R2 is considered unsupervised because the robot is doing things automatically and don't need a teacher to guide it. The patterns establish between pathway R1 and R2 causes the robot to do certain tasks automatically. Self-organization of pathway R1 and R2 with other similar pathways also creates a stronger pattern (FIG. 20).

ABC Block Problem

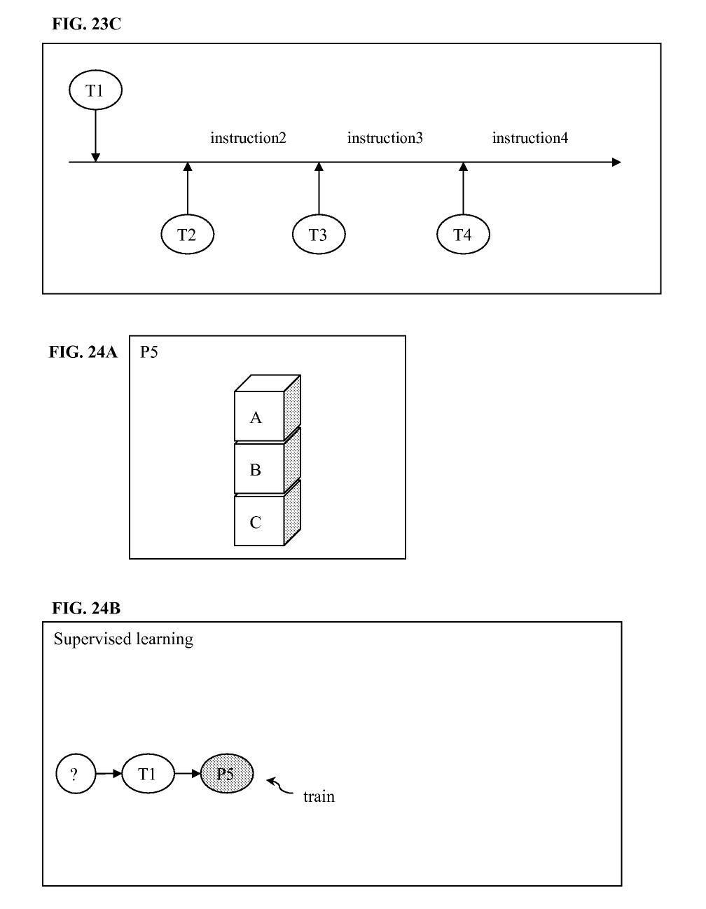

Pathways that have linear steps activate the closest future element objects. FIGS. 23A-B depicts diagrams for solving the ABC block problem. Each task is represented by a sentence or meaning to a sentence. Tasks T1-T4 are the steps to solving the ABC block problem. Each task is followed by instructions that the robot has to do in order to accomplish each task (instructions2-4).

If the robot is trained over and over again by a teacher the lessons to solve the ABC block problem, then data in the pathway becomes stronger and stronger. Data in pathways are structured in a hierarchical manner, wherein the most important data are stationed at the top-levels and the minor data are stationed at the bottom-levels. Language in terms of words or sentences will become strong data. Each instruction is encapsulated by a sentence. Referring to FIG. 23C, the top-part of the pathway are target objects and the bottom-part of the pathway are activated element objects. When the robot recognizes T1 then T2 will activate followed by instruction2. When instruction2 is completed T3 will activate followed by instructions. Finally, when instruction3 is completed T4 will activate followed by instruction4. Because the sequence of steps is consistent, the activated element objects are activated step by step. For example, if T1 was recognized T4 will not activate. T4 can activate if we train the robot to activate T4 after recognizing T1.

Supervised Learning

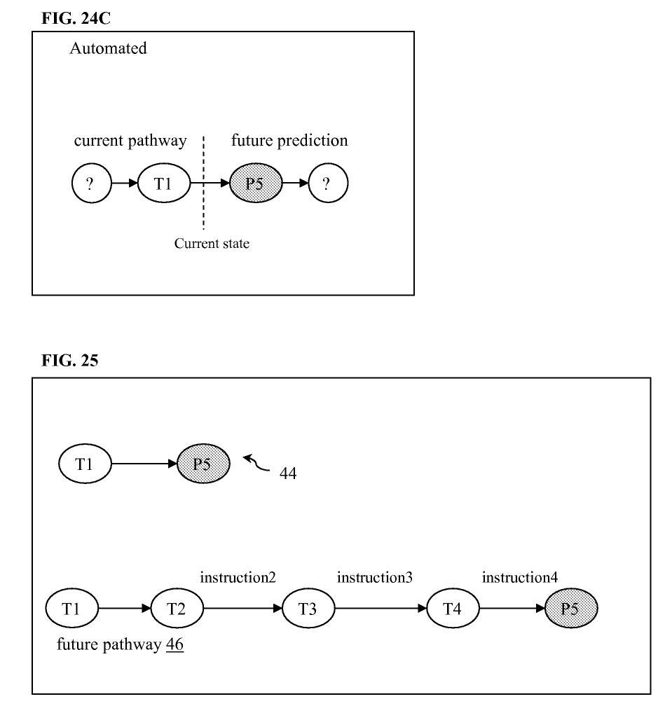

T1-T4 are strong data in the pathway so it's natural that they get activated first, but what about specific data in pathways such as a picture. What if we wanted the robot to activate a picture of the outcome of the ABC block problem after T1 is recognized? The way to activate specific data in future pathways is through supervised learning. A teacher has to give the robot clues and the robot has to find the patterns. FIG. 24A shows a picture P5, which is the outcome of solving the ABC block problem. FIG. 24B is a supervised training by a teacher. The robot is trained with T1 and then followed by P5. The whole idea is to activate P5 after T1 is recognized (FIG. 24C).

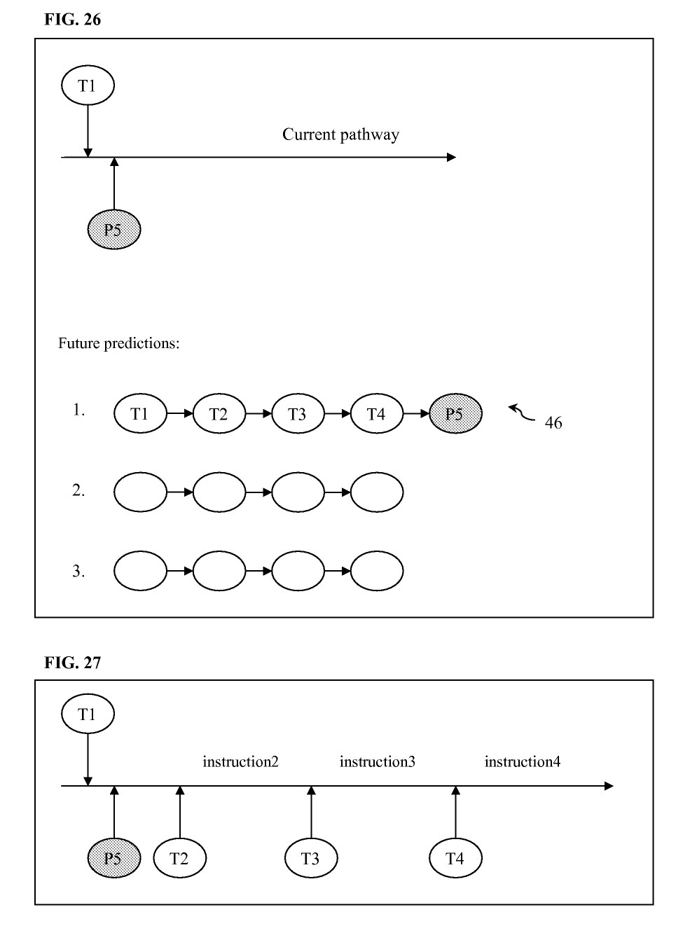

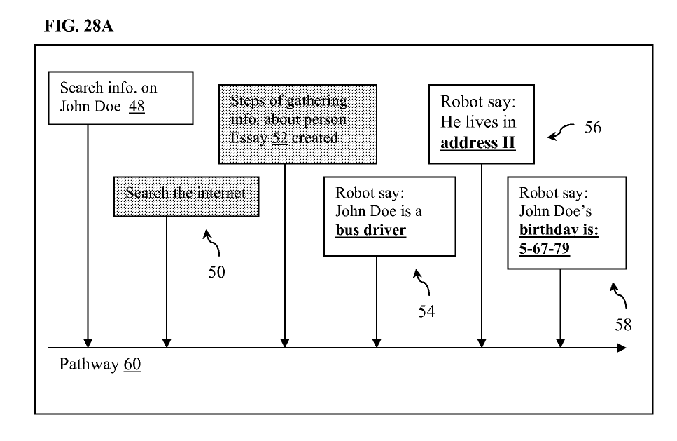

Referring to FIG. 25, the robot will find patterns between the predicted future pathway 46 and pathway 44. Once that pattern is established then the specific data P5 will activate after T1 is recognized. The end result is the pathway in FIG. 26. When T1 is recognized by the AI program P5 will activate, giving the robot a picture of the outcome of solving this particular ABC block problem. Referring to FIG. 27, after a picture of P5 is activated then the steps to solving the ABC block problem will be followed in linear order.

Why didn't the robot automatically do steps T2-T4 and their respective instructions before P5 was activated? The robot actually did do the steps in future pathway 46 (tasks T2-T4). The result of P5 comes from the outcome of tasks T1-T5. The pattern between the supervised pathway 44 and future pathway 46 is that the picture P5 wasn't extracted from a pathway in memory, but it was extracted from the predicted future pathway 46.

The psychic ability of knowing what the ABC blocks will look like before the robot actually solves the problem is a gift. Now, the robot can actually use this knowledge to do other things such as determining wither it wants to solve the problem or not—physically placing the blocks in an ABC format. The robot might even follow the steps automatically. The robot recognizes T1 then it activated P5, next it will do T2-T4. The robot might regard P5 as a “noise” in solving the ABC block problem (FIG. 27).

Simple Internet Example

An example will be given to extract data from the internet and to use this data in the real world. The robot uses the time machine to predict the future. Pathways in memory will be string together in a continuous manner and the robot has use the time machine to trick the future pathways into thinking certain events happened. The time machine is a virtual world and emulates all non-physical and physical objects in the real world. The time machine also contains manually inserted programs such as software, the internet, machinery, wires, computer hardware and so forth. These external programs provide an accurate and realistic depiction of objects they emulate.

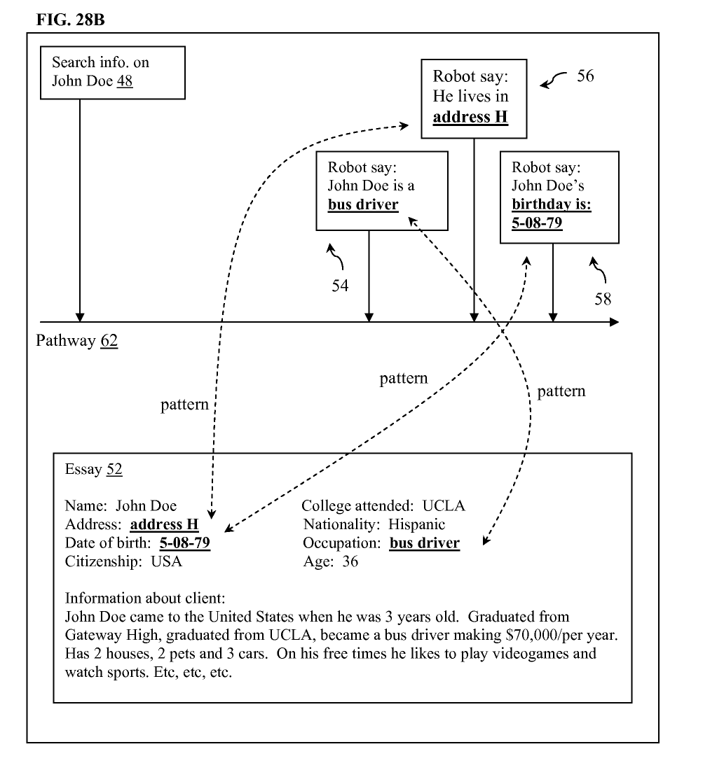

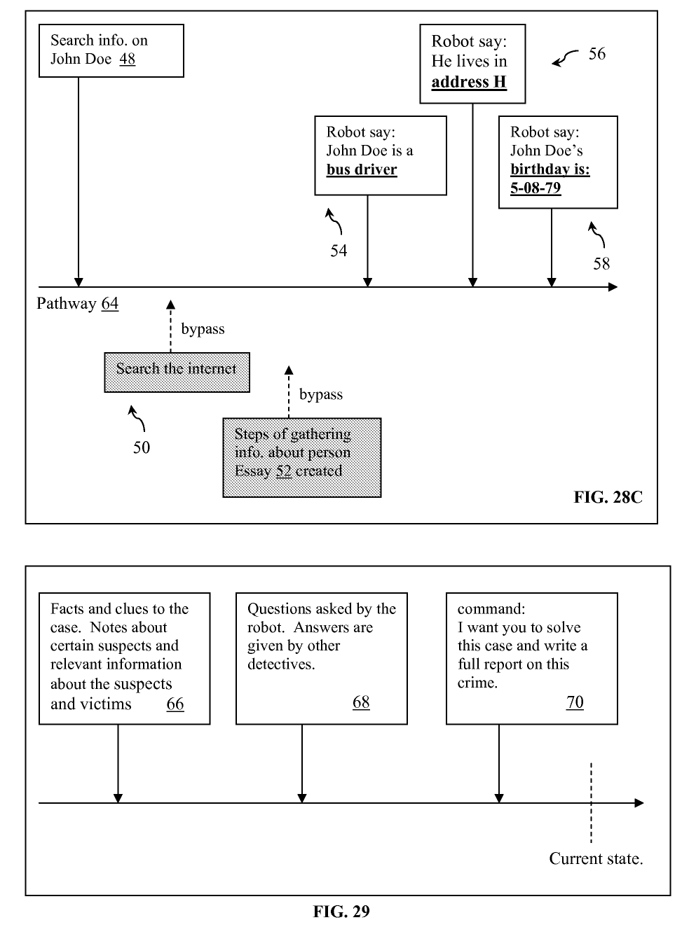

Referring to FIG. 28A, the idea behind this pathway is to train the robot to look for basic information over the internet concerning a person called John Doe. The robot will create an essay 52 on John Doe and it contains background information about John Doe. After creating essay 52, the robot has to say three things: task 54, task 56 and task 58.

Referring to FIG. 28B, a supervised training is created to indicate to the robot what the teacher wants to happen. The teacher will give a command: Search information on John Doe (task 48). The next steps are three tasks: task 54, task 56 and task 58. All three tasks require the robot to give information on John Doe. Notice that in supervised pathway 62 the steps: searching the internet 50 and creating essay 52 are missing. The teacher is trying to train the robot to extract specific information from future pathways. Searching the internet 50 and creating essay 52 are bypassed. The information about John Doe is important and not the steps in getting that information. The teacher wants the information about John Doe right after task 48 is given, which is: search information on John Doe.

Referring to FIG. 28A-B, patterns are established between supervised pathway 62 and the pathway 60. Most notably essay 52, which contain simple facts about John Doe. John Doe's occupation has relations with task 54. John Doe's address has relations with task 56. John Doe's birthday has relations with task 58. By establishing these relational patterns between a pathway and predicted future pathways, the robot will be aware of specific data in future pathways. The patterns create the importance of specific data in future pathways.

Referring to FIG. 28C, after many training and many examples from teachers the robot is able to create pathway 64. The robot will be given a task 48, which is a command to search for information on John Doe. Next, the robot predicts the future, bypassing searching the internet 50 and creating essay 52. The next response is task 54, which requires the robot to say the occupation of John Doe. After that the next response is task 56, which requires the robot to say where John Doe lives. Finally, the last response is task 58, which requires the robot to say the birthday of John Doe. If this pathway is compared with other similar examples a universal pathway will result and the person John Doe can be anyone.

All sentences describing a task in this pathway can be in a fuzzy logic manner. For example, the sentence: search information on John Doe can be replaced with: gather data regarding a John Doe. The three facts about John Doe's occupation, address and birthday can also be in a fuzzy logic manner. The robot's sentences in task 54, task 56 and task 58 can also be in a fuzzy logic manner.

The sentence 48: “search for information on John Doe” is actually a unique marker indicating to the robot that this sentence 48 is a sequence of recognized words that require a unique response. When this sentence is understood by the robot, the robot has located a unique pathway in memory that contains sentence 48 and no other. The longer the sequence of events the more unique the pathway will be. This method can be used to, not only recognize one sentence, but a series of sentences and events.

Referring to FIG. 29, if the robot was trying to solve a crime the robot will be given clues and facts about the case. Then the robot might have some questions and he will ask other detectives for the answers. Events 66, events 68 and events 70 are considered a “marker”. This marker is a series of sentences or events that happen and will eventually lead to a future pathway. I will be illustrating this point fully in the next example.

Universal Pathways

In order to create patterns between pathways the AI program has to compare similar pathways. By comparing similar pathways, the data that are similar or the same can be stronger while the “noise” will be weaker. I will be concentrating this example on the three tasks: task 54, task 56 and task 58. The reason that the tasks are structured this way is because the robot learned the tasks in that order. Tasks can be arranged in any order. If there are variations in sequences of tasks the AI program will select the most dominant task sequence.

| Order of tasks | times encountered |
|---|---|
| Task1 Task2 Task3 | 50 times |
| Task3 Task1 Task2 | 88 times |
| Task2 Task3 Task1 | 20 times |

In terms of the diagram above task3, task1 and task2 has been encountered 88 times, therefore that sequence of tasks will be selected. Sequence of tasks can be as short or long as the AI program wants it to be. In parent applications I talk in detail about the lengthening of pathways. Pathways can also break apart into a plurality of sub-pathways when the AI program forgets information.

The future pathways predicted will use the time machine to create a realistic and accurate environment. Even future pathways that require the AI program to search for information on the internet can be realistic. There are many ways to type letters into a computer, there are many ways to search for information on web pages and there are many ways to extract information from web pages. A robot can be given a task to search for information about a person. If the same task is done 100 times by the same robot each possibility will yield a different outcome, but the outcome should be similar or the same.

By tricking the future pathways into thinking that it is searching for content over the internet via pathways in the time machine, each future pathway is actually doing work intelligently. Each future pathway is being tricked into thinking the events actually occurred. The most important part is the intelligence of the future pathway. The intelligence allow it to brainstorm ideas, come up with logical facts, search for information or write information down on a notebook to be re-looked at in the future.

Self-organization has already averaged out all data in memory so that a fuzzy range of a pathway is created. The intelligent pathways can work under any situation. The pathways don't care what the computer looks like or if the keyboard is dirty or the mouse doesn't work perfectly or what the chair the robot is sitting on looks like or how the keys on a keyboard are arranged or what size the monitor is. The Future pathway to search for information over the internet can cater to any environment or situation. The robot can have its' left arm amputated and it will still be able to search for information on the internet. This is the beauty of human intelligence—the ability to adapt to any changing environment.

This leads to the purpose of the present invention. If the future pathways predicted are realistic and accurate, then the specific data extracted from the future pathways will be realistic and accurate. Patterns establish relations between the predicted future pathway and the current pathway. The patterns extract specific data from predicted future pathways. The robot is able to bypass the searching of the internet for information about John Doe and bypass the writing of an essay for John Doe because the future prediction has already done that part. The robot actually believes that the events occurred. The supervised learning from the teacher created the correct response to a current pathway. The response to the current pathway is a clue and the robot is supposed to find patterns between the response and the specific data in predicted future pathways.

Imaginary Computer and Internet

Initially, a computer should be close-by to the robot so that it can search for information over the internet. Referring to FIG. 28C, as the robot learns this pathway over and over again pathway 64 gets stronger and stronger. Pathway 64 will only work if a computer is close-by. What if there is no computer close by or the computer doesn't have internet access?

Features in the time machine such as the internet or the computer are considered internal functions. I talked about internal functions in detail in parent applications. The robot uses internal functions to reverse engineer how logic is created. The whole idea behind internal functions in the time machine is to access the internet or the computer without actually accessing the internet or computer in the real world. “If it can be done in the time machine (a virtual world), then it should be bypassed in the real world”.

Referring to FIG. 28C, in pathway 64 imagine there is no computer close-by to the robot. The robot will string future pathways in memory that contain a computer and internet. Although it doesn't match to the current situation in pathway 64, the internet and computer is an internal function and pathways of accessing the internet or a computer is very strong and consistent in memory. Thus, the future pathway will magically appear a computer, a chair, and the internet A notebook with a pencil might magically appear as well so that the robot can write down notes.

Objects that magically appear in the future pathways like a computer or the internet should be determined by patterns. Many examples and many experiences of an event have to occur in order for objects to magically appear. If the robot predicts a computer with no internet access then it can make the computer have internet access because it is difficult and time consuming to predict a way to make the computer have internet access. If a car is broken the robot can magically make the car work. If the robot wanted to go from the supermarket to the library then it can magically teleport itself from the supermarket the library. The future pathways should be fabricated so that it benefits the robot in the future and minor errors or obstacles are bypassed. As usual, many training and consistency is required.

If the future pathways contain an internal function such as accessing the internet or a computer the robot should not be aware of a computer magically appearing. For example, it won't think consciously: how did this computer magically appear? It will be like a dream, in which the robot believes that the information gathered over the internet is real and that how it got that information is irrelevant.

Resulting in this Final Pathway—a Pathway with Psychic Abilities

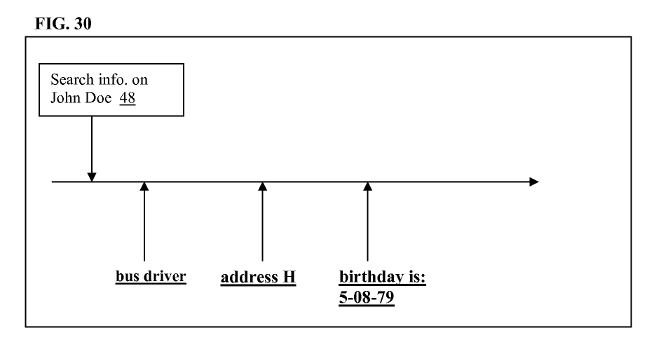

After many training the robot will create the pathway in FIG. 30. Once command 48 is given to the robot then future element objects will activate in the robot's mind: “bus driver”, “address H” and “birthday is 5-08-79”. These are information that was extracted from the internet related to a person called John Doe. These activated future element objects were gathered from predicted future pathways. These “psychic” data can be in the form of the 4 different data types: 5 sense objects, hidden objects, activated element objects or pattern objects. The “psychic” data can be words, pictures, movie sequences, touches, smells or a combination of senses. Other intelligence can be created in the pathway to interpret what these “psychic” data means. For example, if “bus driver” is activated, the robot can also activate logical thoughts such as: “John Doe's job is a bus driver or someone in his family drives a bus”. If “address H” is activated, the robot can also activate logical thoughts such as: “this must be John's address or he lived in this address in the past”.

If this pathway is compared with similar pathways in memory, then a universal pathway will form. This universal pathway can cater to any person. John Doe in command 48 can be replaced with any person's name. The pathway will activate “psychic” data about that person, most notably his/her occupation, address and birthday. The supervised learning guides the robot what to activate. The supervised learning serves as the ideal response in a pathway. This method is similar to how neural networks are trained. The ideal response in a pathway can be any sequence of tasks. If there are many similar sequence of tasks the robot will select the most dominant one.

Creating a Book or Research Paper Example

All work done in the time machine stays in the time machine. If the robot's future pathways are tricked into drawing a picture, then the final picture will be a physical object in the time machine. If the robot's future pathways are tricked into writing a book, then the final book will be a physical object in the time machine. Every single work done by each dominant future pathway is stored in the time machine. This would include: writing a book, drawing a picture, writing software codes, operating a computer, playing a videogame, reading a book, searching for information on the internet, making a bronze statue and so forth.

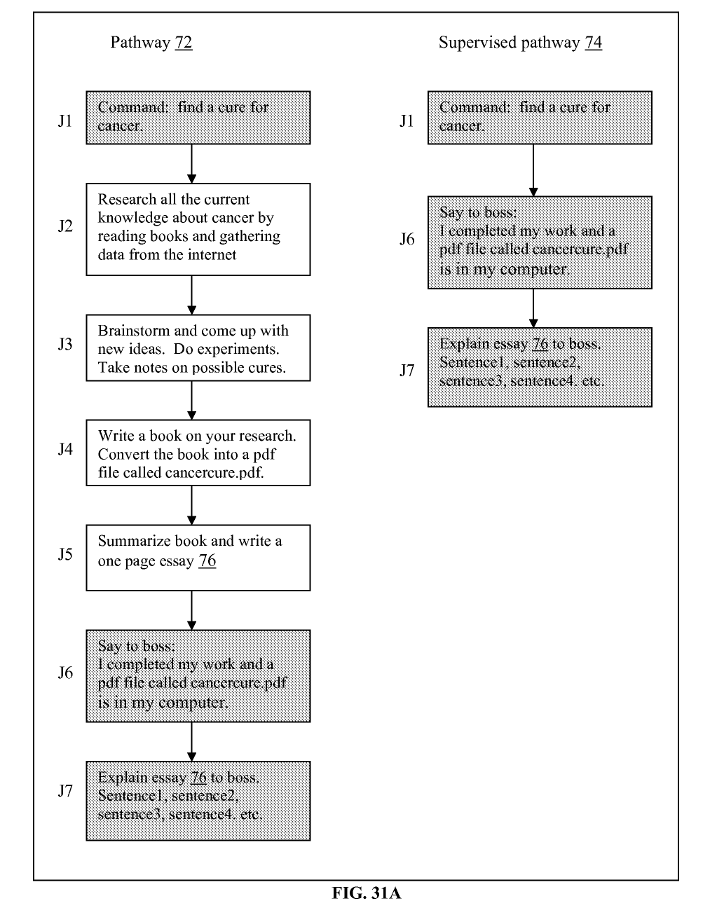

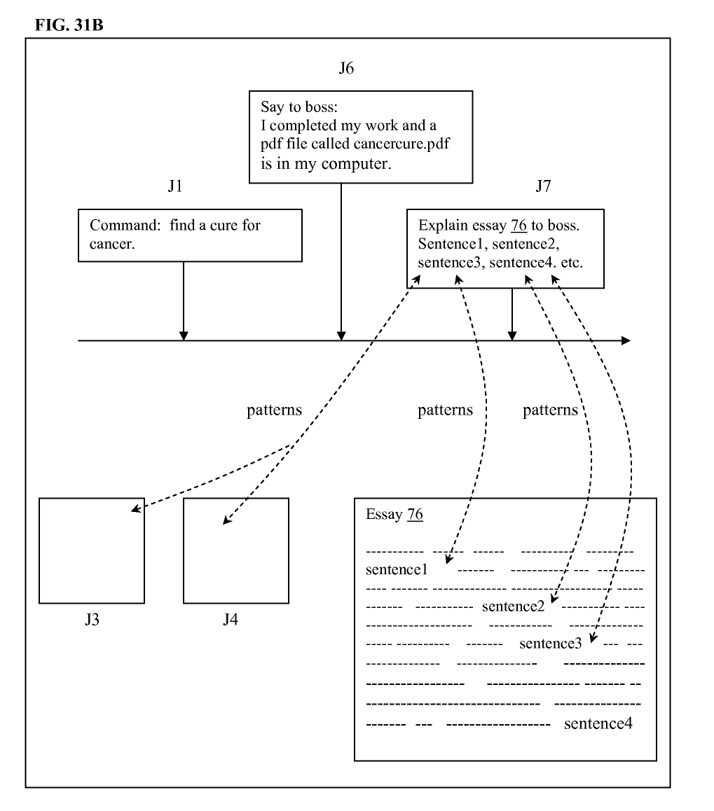

Referring to FIG. 31A, pathway 72 is trained many times by the robot. These are the steps that it takes to write a book (or to accomplish any task). In J1 the robot is given a command to: find a cure for cancer and to write a book. Steps J2-J5 are the steps the robot has to take to cure cancer and write a book about the cure. In step J5, the robot has to summarize the content in the book and present a one page essay 76. In step J6 the robot will say to the boss that he has found a cure to cancer and a pdf file called cancercure.pdf is stored in his computer. In the last step, J7, the robot has to explain the essay 76 to his boss using sentences from the essay 76. Steps J1 to J7 are the steps the robot has to take in order to create a book on a cure (or several cures) to cancer.

In Referring to FIG. 31A, supervised pathway 74 is taught to the robot by a teacher. Step J1 is the “marker” and step J6 and step J7 is the ideal response. The idea is to bypass steps J2-J5 and use the future pathways as a substitute for steps J2-J5. The creation of the cancer book should be “work” done from the future pathways and not from “work” done in the real world. The key to bypassing steps J2-J5 is to provide relational patterns between the ideal response (step J6 and step J7). FIG. 31B is a diagram depicting relational patterns between data in step J6 and step J7 to essay 76, step J3 and step J4. Data that the robot will say to his boss in step J7 such as sentence1, sentence2, sentence3 and sentence4 have patterns with data in essay 76. Step J7 not only has patterns with essay 76, but also, has patterns with step J3 and step J4.

Tricking the Robot

During the supervised training (supervised pathway 74), a teacher has to make up a “fake” book about cancer and put that book as a pdf file in the robots computer. This “fake” book should be similar or the same to a book that the robot will presumably write in the future. By doing this the robot is tricked into believing that the book just magically appeared in his computer and the robot had nothing to do with the writing of the book. The robot will some how use the patterns described in FIG. 31B and find out that in predicted future pathways the robot has written a similar book with similar contents. This will ultimately link the robot's predicted future pathway with supervised pathway 74. The end result is supervised pathway 74 has a command step J1, steps J2-J5 are done by predicted future pathways, and steps J6-J7 will be done by the robot—Steps J2-J5 will be bypassed and the contents from J6-J7 will be from data in predicted future pathways or stored as objects in the time machine. For example, the book cancercure.pdf is stored in the time machine. The book was created, not from the robot doing “work” in the real world, but from “work” done in predicted future pathways. The robot's computer should be linked to the computer in the time machine.

This example illustrate how the robot can, not only do work such as write a book or do research, but also extract specific information from predicted future pathways. In FIG. 31B, sentence1, sentence2, sentence3 and sentence4 is extracted from a future pathway and are used to explain to the boss a summary of the cure for cancer. The patterns link what the robot will say in step J7 to specific data in predicted future pathways. Sentence1-4 can also be in a fuzzy logic manner, wherein the meaning of sentences is more important than what the sentences look like.

Finding Patterns to Long Future Pathways.

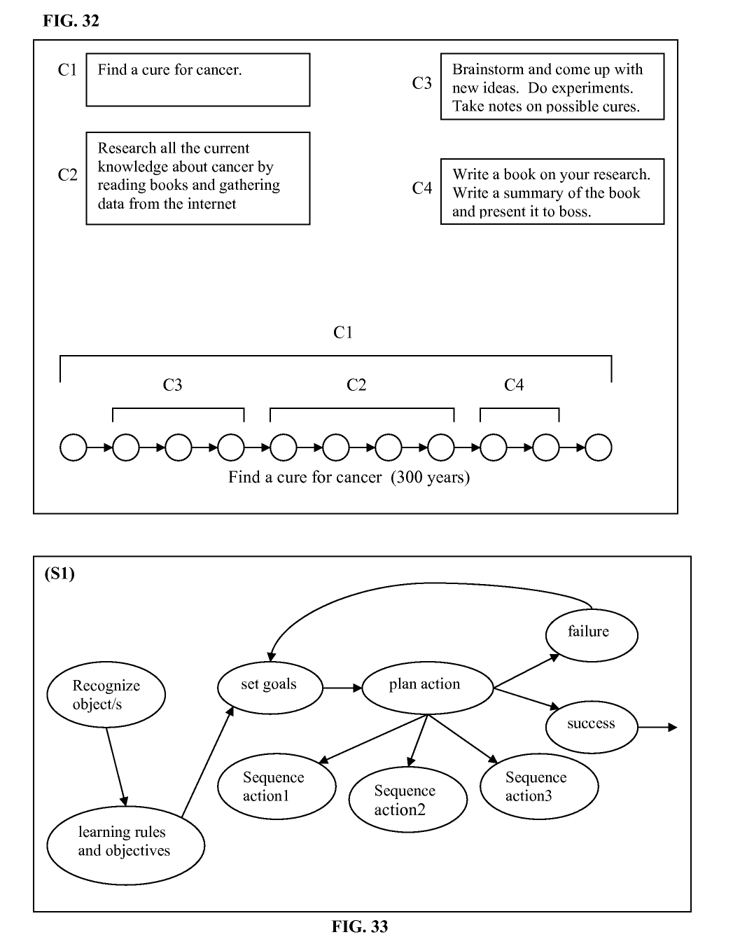

It is simple to find patterns between a supervised pathway and a short future pathway, but what about very long future pathways. What if the future pathway is 12 days or 23 months or even 300 years? How are the patterns between the supervised pathway and the long future pathway established? The answer is by comparing data in a hierarchical manner, wherein the most important data gets compared first before the minor data gets compared. Language in the form of words and sentences will also help tremendously in terms of comparing ambiguous situations. Words and sentences can represent the existence of objects, actions or entire situations. For example, imagine that it takes the robot 300 years to find a cure for cancer. If we tried to compare all the data in 300 years of movie sequences that would be impossible. On the other hand, sentences can represent data in 300 years worth of movie sequences. FIG. 32 depicts a diagram illustrating how 300 years of movie sequences can be broken down into 4 sentences (C1-C4). Each section of the movie sequence is represented by a sentence. Every frame-by-frame of each section in the movie sequence is considered the existence of an object, action or a situation.

Future pathways will be compared with supervised pathways using hierarchical data analysis. Usually words and sentences will have top priority, then average objects, and then specific objects in a pathway. This means the AI program will compare words sentences first (the existence of an object, action or event), then it will compare average objects that has been trained repeatedly and finally, it will compare specific objects. The strongest data in a pathway with the most powerpoints and priority will be compared first.

The second way of comparing data between a supervised pathway and a future pathway is by self-organization. 4 different data types will self-organize pathways together: 5 sense objects, hidden objects, activated element objects and pattern objects. Pathways also builds on itself. Referring to FIG. 33, pathway S1 is a universal adaptive pathway. It can cater to short pathways or long pathways. Tasks in a pathway that require 5 minutes can be stored in pathway S1 and tasks in a pathway that require 300 years can also be stored in pathway S1. Universal pathways organize data in pathways regardless of the length. It also organizes pathways so that similar pathways are grouped close to each other. By having a series of similar pathways stationed close to each other, the AI program can search for patterns by using the strongest data in the universal pathway.

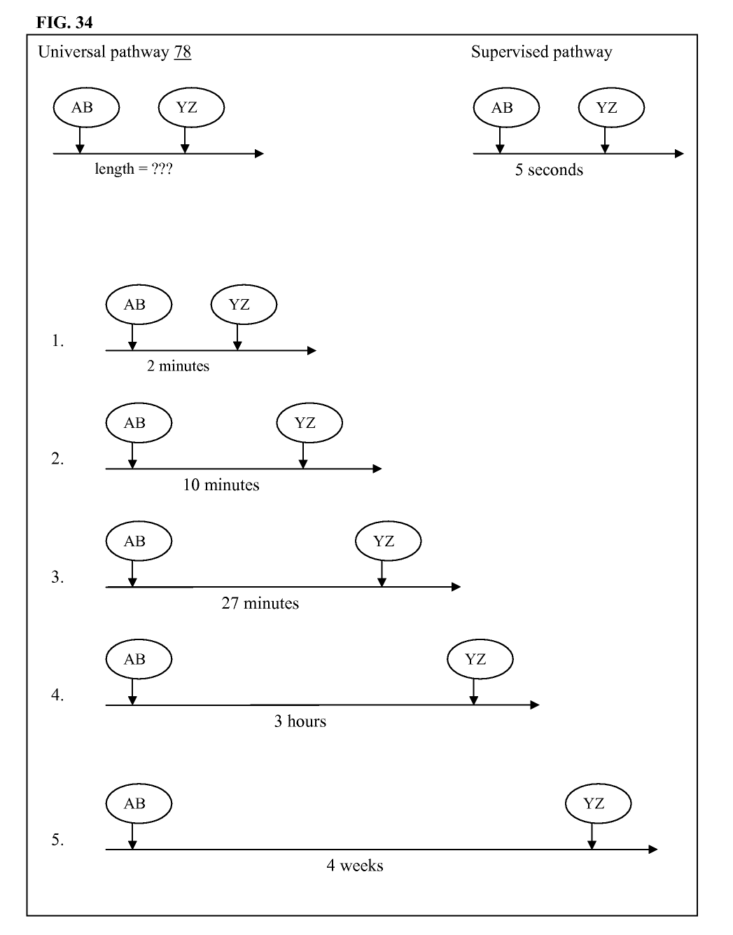

FIG. 34 is a diagram of a universal pathway 78. Notice that pathways that are contained in the universal pathway 78 are organized by length (this is only one property of self-organization). By comparing the pathways close by it will be able to lock onto patterns that point to specific data, giving the AI program an approximate area to compare. The AI program can also rule out certain data between pathways by using a process of elimination. Data will be compared hierarchically.

Gathering Knowledge and Facts from the Time Machine

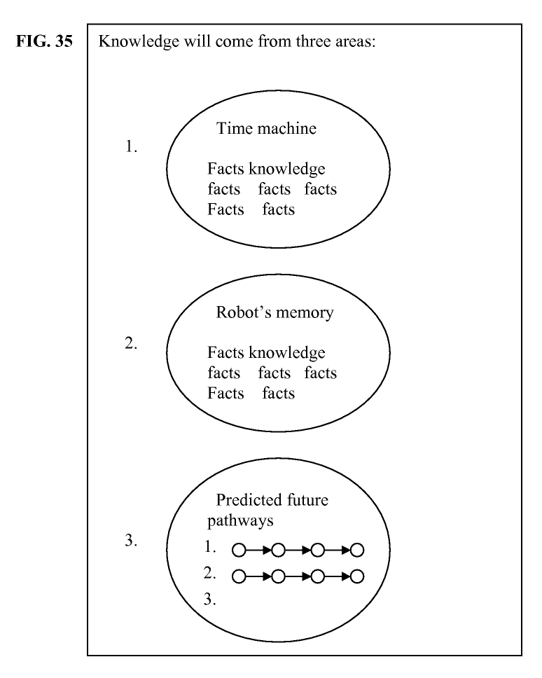

There are three areas the robot will gather knowledge from: pathways in the robot's memory, pathways in the time machine and data in predicted future pathways (FIG. 35). The time machine is created from the experiences of multiple robots living in the same environment. The time machine gather 2-d pathways from multiple robots and store these pathways in such a way that a 3-dimensional environment is created. The pathways store information and facts about the environment. Facts about an object are stored near that object. Stereotypes about an object are stored next to that object.

If the robot needed to gather information about John Doe, he can gather information from: its own memory, predicted future pathways or the time machine. The time machine contains the collected knowledge of all robots that is linked to it. If one robot (call this robot: Sam) is a friend of John Doe then Sam's knowledge of John Doe will be stored in the time machine. If the AI program wanted to find information about John Doe he can either look into the time machine for that information or search the internet in the time machine for relevant knowledge.

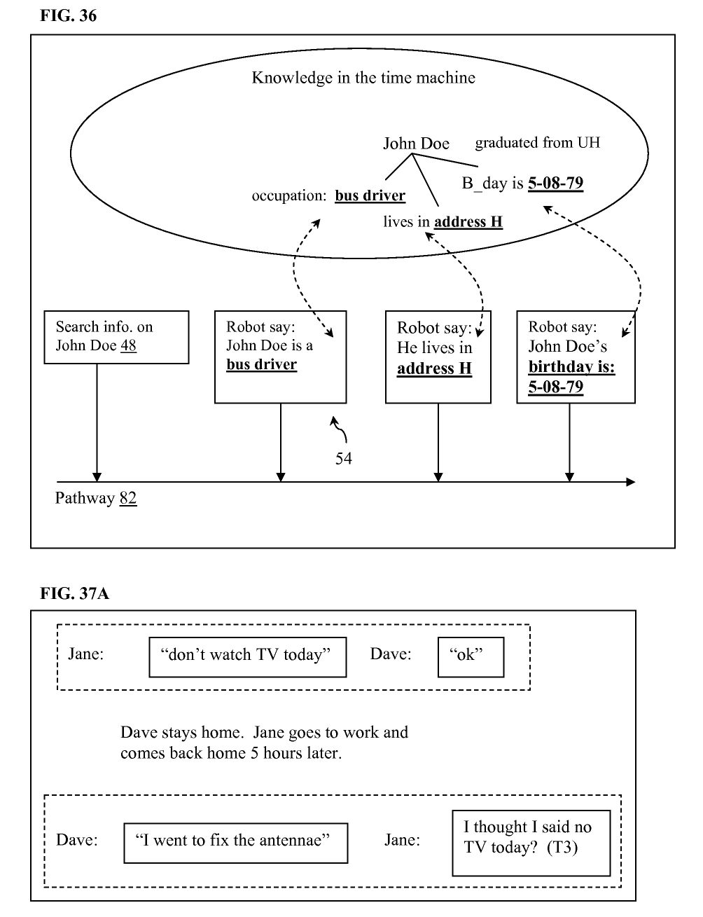

The robot can find patterns in three areas: the robot's memory, predicted future pathways and the time machine. For example, FIG. 36 depicts a diagram of the robot finding patterns between knowledge in the time machine and pathway 82. The pattern is that the robot has to search for a person called John Doe in the time machine. Then he has to extract specific facts about Mr. Doe and use these facts to output a sentence to his boss. For example, in step 54, the robot has to say: John Doe is a R1. R1 comes from the search pattern: occupation: R1 in the time machine. The robot will search for “occupation: ???” and extract the continuation of the sentence. In this case R1 is bus driver. In step 54 the robot will replace R1 with bus driver and the sentence spoken to his boss will be: John Doe is a bus driver.

Patterns are only found when this pathway is compared with similar pathways in memory to create universal pathways. The whole idea is to extract information regardless of who John Doe is—John Doe can be replaced with any name, but the pattern should extract the correct facts. For example, if John Doe was replaced with Dave Smith and Dave Smith's occupation is a heart surgeon, then R1 will be heart surgeon and the sentence outputted in step 54 will be: Dave Smith is a heart surgeon.

Hidden Activation and Open Activation

The conscious comprises two types of activation: hidden activation and open activation. Hidden activation occurs when an element object is activated, but it doesn't enter the mind. Deep logical thoughts use this type of activation in order to come up with intelligence. On the other hand, open activation is when an element object is activated and enters the mind. The mind has a limited amount of space and the element objects that activate there are the things the robot is aware of.

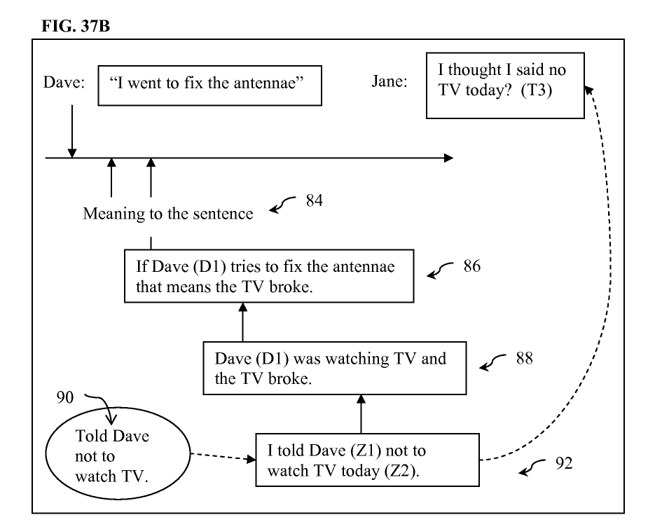

To illustrate this point, FIG. 37A depicts a diagram that shows how logical thoughts are created.

In FIG. 37A-B the reasoning behind this situation is that Jane told Dave not to watch TV on that day. When Jane came home from work Dave said that he went to fix the antennae. The logic behind T3 is that Jane knows that the antennae is attached to the TV and that the TV must have been broken. The only way that the TV broke is if Dave was watching TV and something happened to it. The way that the AI program outputs the logic in T3 is by sentence association. The more times the robot learns knowledge about a situation the more likely that knowledge will be activated by the rules program. Knowledge could be any data in memory, most notably sentences or movie sequences.

When Dave said: I went to fix the antennae, Jane activated the meaning 84. Then Jane activated fact 86. Fact 86 had strong association to fact 88 so that gets activated. Fact 90 combined with fact 92 activated logic T3. Logical thoughts come from a cascading affect, wherein element objects from recognized target objects as well as activated element objects compete to be activated. In terms of logical thoughts, consistent learning of a logical sequence from school teachers will activate that logical sequence.

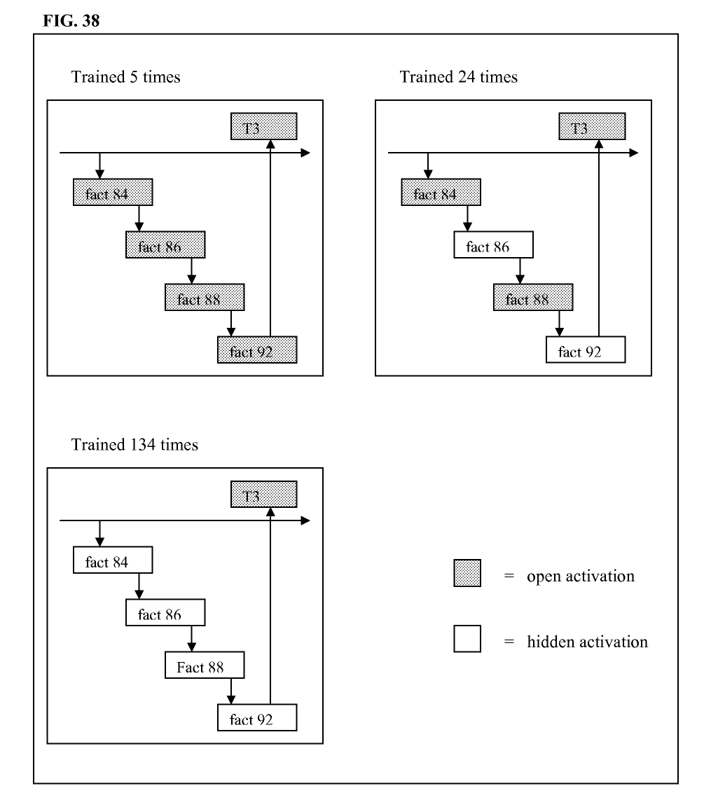

Referring to FIG. 38, facts 84, 86, 88, 92 and T3 will no doubt be activated in the conscious because all facts have to be activated in linear order to come up with logic T3. The question is: which facts are considered hidden activation and which facts are considered open activation? The stronger and more consistent a logical thought is the more likely less element objects will be open activation. In other words, the AI program will go directly to the logical thought T3 instead of activating every fact in that logical sequence. FIG. 38 is an illustration showing how learning can prevent all the facts in the logical thought to activate. Instead, the AI program activates the logical thought T3 directly bypassing all facts that lead up to logical thought T3. The grey blocks are open activation and the white blocks are hidden activation. The grey blocks will enter the mind while the white blocks will not enter the mind.

Solving a Crime Example

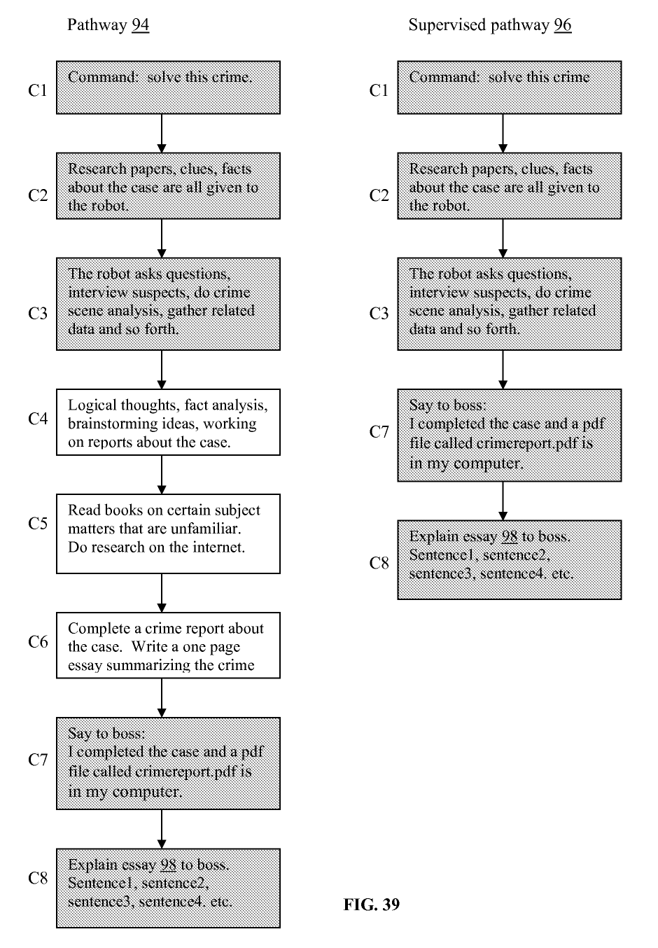

A more complex example is giving the robot the task of solving a crime. FIG. 39 is a diagram depicting a pathway 94 to solve a crime. There are some tasks that can't be done in the time machine, but has to be done in the real world. Tasks such as interviewing suspects and visiting the crime scene and so forth are tasks that can't be done in the time machine. Suspects are intelligent and unless the time machine can copy a suspect as a virtual character, then the suspect can only be interviewed in real life. Another task that can't be done in the time machine is recreating the crime scene. Even a microscopic hair can be used as forensic evidence. Unless the time machine can recreate the crime scene perfectly (atom by atom), evidence has to be gathered in the crime scene in the real world.

On the other hand, tasks that can be done in the time machine are: gathering data from the internet, reading books, doing research, brainstorming ideas, coming up with logical thoughts, writing a crime report or analyzing all data gathered relating to the case. In FIG. 39, the idea behind supervised pathway 96 is to train the robot to do things in the real world and to bypass things that the robot can do in the time machine. Supervised pathway 96 should also have an ideal response. Tasks C1-C3 are tasks that must be done in the real world so they are included in supervised pathway 96. Tasks C4-C6 are tasks that can be done in the time machine, so they are excluded from supervised pathway 96. The ideal response is tasks C7-C8, which is the output of the pathway. The ideal response (tasks C7-C8) are also clues for the robot to find relational patterns between a predicted future pathway and supervised pathway 96.

When the robot is trained with pathway 94 and supervised pathway 96 many times, it will create an unsupervised pathway, wherein tasks C1-C3 will happen, tasks C4-C6 will be bypassed and tasks C7-C8 will happen. The output of pathway 96 is: a pdf file called crimreport.pdf will be created in the robot's computer and the robot will tell his boss a summary of the crime—who the primary suspects are, what the timeline of the crime is, who the victims are and so forth.

Other Topics:

Different Types of Robots are Linked to the Time Machine

Multiple robots are linked to the time machine. If you look at the human race, there are many types of humans. There are African people, White people, Asian people, Mexican people, short people, tall people, old people, young people, handicapped people, females, males and so forth. In the time machine the definition of a robot can be anything. A robot an be a human being, an animal, an insect, a bacteria, a tree, a plant or an artificially created human being. All these robots will help create the time machine.

Different robots have different senses, so the question of compatibility should be asked. I think that for the most part a robot's pathway will self-organize in memory based on the closest robot it resembles. For example, pathways from a human being will most likely be stored in pathways of a similar human being. Pathways from a male human being will be stored in pathways from a similar male human being. Pathways from a cat will be stored in pathways from a similar cat.

For the most part the robot will be accessing information and facts from a similar looking robot in the time machine. In some cases the robot might access pathways related to an animal or an insect. For example, if the robot is investigating the death of an animal, “psychic” data might include visual data from the dead animal. Or animals that witnessed the crime might have their pathways accessed because these animals are related to the crime scene. Patterns and association will ultimately determine what types of species' data to access.

On the other hand things like animals and insects can actually help fill in new data that are missing from human beings. For example, a building witnessed by many robots will create a 3-dimensional environment of the building from the inside and out. Insects and bacteria can actually fill in the details in this 3-d environment. Every single area the insect has crawled will be recorded in the 3-d environment. Birds can fly over the same building and a view of areas that human beings can't access will form in the 3-d environment. Bacteria can form atomic structure in the walls and objects like table, door knobs and ceiling. The question about compatibility is the key. How does the bacteria know where to store its experiences in the 3-d environment.

My guess is that animals form a 3-dimensional environment first and then it somehow merges with the 3-d environment of a human being. The images of an animal and a human being have similarities. Animals see the same images as a human being, but their sense of color are different. An animal might have 3 different colors to create an image, but the human eye has over 64 different colors. Even the visual sense from a bug has some form of similarity to a human visual sense. These 3-d environments from different species will merge together based on commonality traits.

Another theory is that the relative location of an animal seen by a human being will indicate to the time machine where to store pathways from the animal. For example, if a human being is in a famous park and sees a cat, then the time machine will store that cat's pathway in that area. The location of that robot in the 3-dimensional environment will help it to store its pathway in that area. If a bacteria is located on a wall then that bacteria's pathway will be stored there. Animals, insects and bacterias are mostly visual species and don't rely on intelligence (animals that don't have a language will only store commonality groups). This means, what they see is what will be stored in memory. Self-organization will only group commonality groups and not learned groups from these animals.

Objects can be Inserted into the Time Machine

Things that are complex such as software, machinery, computer hardware and the internet are inserted manually in the time machine. Also, objects such as books and magazines can also be inserted into the time machine. This is important because the robot might have to do research in a library. The books in the library should have text and pictures so that knowledge can be found. The library environment should be as realistic as the real world in terms of searching for certain books, where certain books are located and so forth.

A book can be read by a robot and the robot will create that book in the time machine. On the other hand, a programmer can manually insert books into the time machine. The creation of the book should be an exact copy of the same book in the real world.

Combining Multiple Pathways Together to Predict the Future

In some cases the AI program has to combine multiple pathways together to predict the future. If pathways in memory are scarce and limited to the current pathway, multiple pathways can be combined together to work out more accurate future pathways. For example, if the robot is playing an unfamiliar videogame for the first time, its future actions will not be optimal. In case there are limited pathways or no pathways regarding a videogame the robot will combine multiple pathways together.

Creating future pathways from multiple pathways is a little tricky. Elements in each pathway are compared with elements of other pathways. Analytical skills will determine what the contents will be in each future pathway. This method works well with combining different environments together in a videogame. This method will prevent the player from bumping into walls or tripping over rocks. The interaction of the player to the environment will be more accurate and depicted in future pathways.

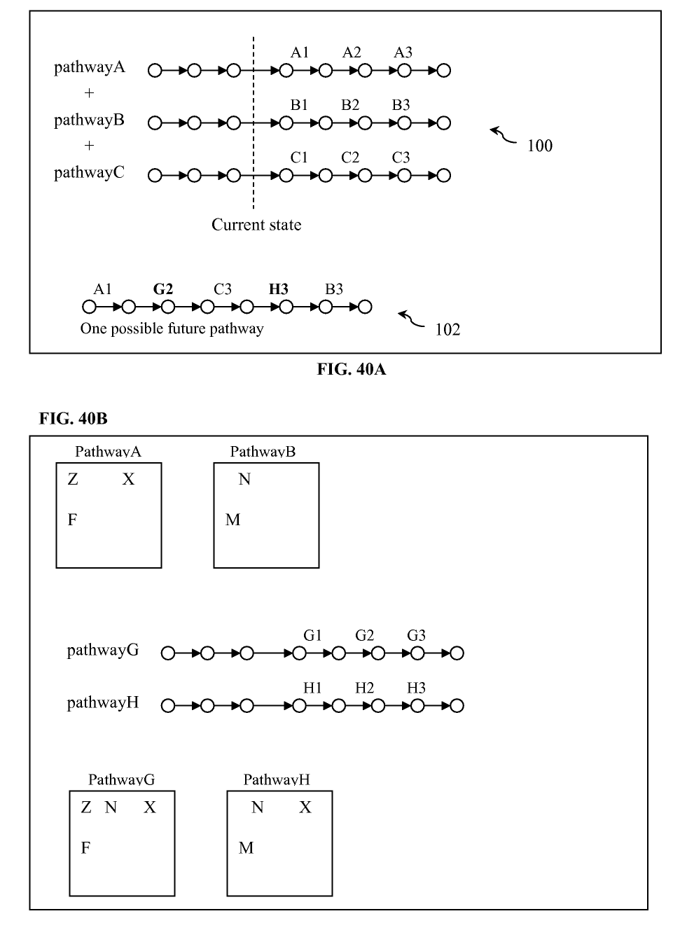

Referring to FIG. 40A-B, pathwayA is combined with pathwayB and pathwayC, creating a pathwayABC. Each pathway has their respective future pathways in memory (pointer 100). One possible future pathway 102 will result and this future pathway will have an accurate depiction of the future for pathwaysA-C.

The key is that all elements in each pathway will be compared with all the elements of other pathways. For example, pathwayA contains elements ZXF and pathwayB contains MN. The AI program will string together elements from different pathways and use its future pathway. The result is pathwayG, which contains ZXF from pathwayA and N from pathwayB. Another result is pathwayH, which contains X from pathwayA and NM from pathwayB. In future pathway 102, G2 and H3 are used in the future pathway.

This method actually provides analytical data on combinations of pathways. This will provide the AI program with a more realistic and accurate depiction of the future. It normalizes all the possible pathways found in memory to come up with new pathways that are not stored in memory. This method is very complex and requires additional computer calculations. However, it can also be used to predict outcomes of an unknown environment. For example, if the robot had to predict the future pathways of a new movie (the robot never saw this movie before), if the robot see the first 10 minutes of the movie, it can use that data to predict what the rest of the movie will look like frame-by-frame. Logical analysis in terms of lessons in school will also play a role and also the ability for the computer to combine pathways together and to create possible accurate future pathways.

This method works great with videogame environments because the interaction between objects are limited and possible outcomes repeat itself over and over again—combining many environments together such as: pathways that include the player and enemies, pathways that include the player and the environment, pathways that include the player and a partial environment, pathways that include enemies and the environment and so forth. All these pathways will be combined together to form hybrid pathways that may or may not be stored in memory. It also provides the AI program with information to come up with an optimal pathway that is already stored in memory.

One videogame example is: if there is a pathway that contains the player and enemy1 and there is another pathway that contains the player and enemy2 and there is another pathway that contains the player and the environment, what exactly will the player do in the future when all three pathways are combined? The answer is by comparing elements in one pathway with elements in other pathways. The AI program will sort out what the probable outcomes of each pathway will be and fabricate accurate future pathways based on the combination of all three pathways.

Combining pathways together is only used in the time machine and not the human artificial intelligence program because task interruptions and managing multiple tasks are done through the human conscious. The conscious will help the robot to sort out conflicts in pathways. The conscious also helps to sort out ambiguous situations. Combining pathways together is mainly used for creating a more realistic view of the environment in the time machine—to create settings that the robot is not aware of.

Hidden Objects in the Time Machine

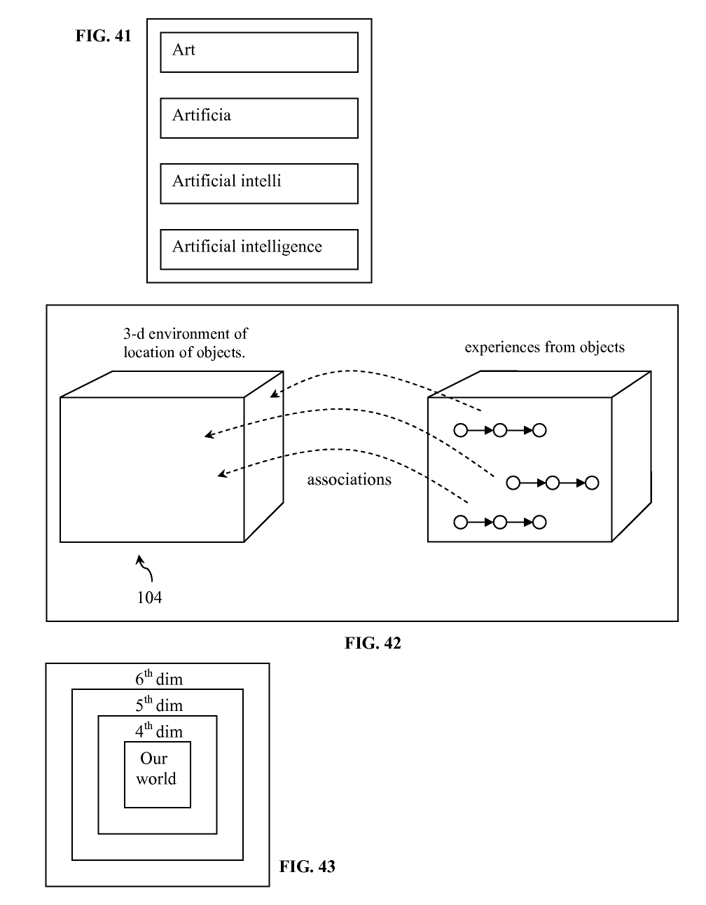

Billboard example—If a videogame has a billboard that displays letters in a way that a math equation can be derived, then the AI program will insert that equation into the universal pathway. This universal pathway will have the math equation to predict the outcome of displaying letters on the billboard (FIG. 41).

Swirling pictures example—a picture distorted by a swirling equation. Some websites distort a face of victims of a crime by using programs that swirl an image. There exist another program that can unswirl a distorted image. If there are any math equation that is repeating such as the swirling of an image, then the AI program should be able to derive a math equation on what image is being distorted and what that image looks like after the distortion.

Gradient colors and changing color properties are also objects that can derive math equations from. If there was a cube that has rainbow colors moving from left to right, then the AI program should derive a math equation for the movement of colors in a 3-d object.

Water example—movements of ambiguous objects such as water can be found by averaging similar water pathways. The water properties will be different farther away from shore than closer to the shore. The water farther away from shore is calm, while water close to the shore is chaotic. The movement of water in a pool is different from the movement of water in a cup. The AI program will derive math equations for water movement for each environment.

Shadow example—Shadows follow an object in a fixed way depending on where the light source (or multiple light sources) is. The AI program should find a pattern and derive a math equation of where shadows will be between a light source/s and an object. This way if the robot has to predict where the shadow of an object should be in different times of the day, then the robot will be able to predict the outcome. If there are no exact or similar pathways in memory in terms of the shadow of an object, the robot will use math equations to fabricate a shadow of an object in relations to the light source/s.

Advance Topics on the Time Machine

This section is devoted to make improvements on the current time machine. The current time machine uses experiences from intelligent species like human beings to create a 3-d environment. In this alternative embodiment, the time machine is broken up into two parts. This alternative time machine comprises two parts: 1. a 3-d environment of locations of objects (FIG. 42, pointer 104). 2. experiences from objects. An ideal time machine is to have every single object that exists in our environment to be emulated in the virtual environment in the time machine. Objects in this case would be: insects, animals, bacteria, human beings, atoms, and things that make up atoms such as electrons, protons and neutrons. All objects, inanimate or animate, will be stored in the time machine as physical objects. Each object's location in the time machine will also be stored.

The time machine will record the existence of all atoms and their location in a sequential manner (frame-by-frame). Every millisecond that passes the time machine has to record the exact locations of atoms and their movements in the environment.

Inanimate objects such as books and rocks will not have any experiences recorded (pathways). However, any intelligent object such as insects, animals, human beings, bacteria and so forth will have experiences; and all these experiences will be stored in the time machine. Pathways in an intelligent object will establish associations to the 3-d environment 104. 2-d movie sequences create a 3-d environment and this 3-d environment will associate itself with the physical 3-d environment 104.

These two things: the physical 3-d environment 104 and the experiences of objects will provide the time machine with lots of detailed information. Detailed information about our environment is needed because that is the only way to predict the future or past with pinpoint accuracy. Very complex future predictions need lots of data from the environment. Being able to predict the actions of, not only a human being, but multiple human beings is a very difficult task. It requires the robot to have data regarding how each human thinks and link these thoughts to their future actions. The robot needs the exact atoms of each person's brain and to know what they are thinking at every millisecond. Every neuron that is fired from each brain must be understood by the robot. Because there are too much information to zip through the robot should predict the future in a hierarchical manner—predict the electrical discharges in the brain first, then predict average pathways activated and finally, predict specific pathways activated. Human beings do not have this capability. Hopefully, these machines will have this ability; and have the capability to predict events that happened in the past and also predict events that will happen in the future.

Predicting an earthquake one year in advance isn't entirely impossible, but plausible. In fact, predicting an earthquake 300 years in advance can be possible. The key is the robot needs detailed information about the environment.

Some animals react strangely 24 hours before an earthquake hits. There might be some kind of sense they have that tell them a major event will happen. Because the time machine, not only stores experiences from human beings but also animals, the robot accessing information in the time machine can use the experiences from animals to find patterns that lead up to an earthquake.

Referring to FIG. 44A, imagine that an earthquake happens, all species affected by the earthquake will have their experiences heightened—the earthquake causes pain for each species. This makes pathways that lead up to an earthquake stronger. If many experiences from different species are compared, there might exist a pattern. The longer the length of the pathway leading to an earthquake, the better the future prediction. The physical structure of the ground (its layered plates) will also be compared for any patterns leading up to the earthquake. The data will also be compared in a hierarchical manner wherein the physical structure of the ground will be broken up into encapsulated areas.

These pathways from different species will create a universal pathway. The strongest data in the universal pathway will activate in the robot's mind when the robot encounters target objects associated with earthquakes. If the robot was doing research on earthquakes these strong data will activate in the robot's mind. The robot can even tap into experiences of specific earthquakes. FIG. 44B depicts an example of how strong data related to experiences from earthquakes activate in the robot's mind.

Using Logical Analysis to Come Up with Meaningful Ways to Interpret “Psychic” Data

Referring to FIG. 44B, when data2, data4 and data6 are activated in the robot's mind, the robot can use intelligent thoughts learned in school to interpret the “psychic” data. This information may be in the form of visual images from animals, insects, human beings or even simple patterns. The robot has to use intelligence to sort out what the “psychic” data really means and how the robot can use this “psychic” data to predict an earthquake.

This “psychic” data doesn't just apply to earthquakes, but all problems in life. If the robot had to solve a kidnapping case, the “psychic” data might be coming from the victim's vision or the victim's sense of touch. It is given that the victim is linked to the time machine and the victim's experiences are stored in the time machine. The robot might look at a picture of the victim or touch an item belonging to the victim and “psychic” data will pop up in his mind.

Learning how to Use Psychic Powers

The robot can actually control what kind of “psychic” data he will activate in his mind by using supervised learning. Using supervised pathways will activate specific data from predicted future pathways. If the robot doesn't want to activate certain “psychic” data then don't train it with the supervised pathway. Eventually, if the supervised pathway is not re-trained the robot will forget; and the supervised pathway that will activate specific data from the future will be deleted from memory.

If the robot wants to have specific data from predicted future pathways activate in its mind, then all he has to do is train itself with a supervised pathway. The more supervised pathway it learns the stronger that “psychic” data will be. This is convenient because the robot decides what kind of “psychic” data it wants to activate in its mind. Any “psychic” data it doesn't want to activate in its mind can be forgotten.

Language can also decide if certain “psychic” data will activate in the robot's mind or not. Patterns can be established between sentences and the increase or decrease strength of a supervised pathway.

Pain and Pleasure

If future element objects (psychic data) activate, the robot will use this activated future element object to do a task. If the activated future element object is wrong, then the outcome of the task will lead to pain. If the activated future element object is correct, then the outcome of the task will lead to pleasure. Any pathway that leads to pain will have their powerpoints lowered and any pathway that leads to pleasure will have their powerpoints increased.

In terms of activated future element objects, if the pathway leads to pain, the supervised pathway will have its powerpoints lowered. If this process is repeated for the same supervised pathway, then that pathway will no long be used by the robot in future decision making. In other words, the “psychic” data it activates will not be activated when the robot is confronted with the same situation in the future. However, if an activated future element object is correct and it leads the robot to pleasure, then that “psychic” data will be activated in future decision making.

Time Travel

Life is a recursion (FIG. 43). Our world is encased in the 4^{th} dimension and the 4^{th} dimension is encased in the 5^{th} dimension and the 5^{th} dimension is encased in the 6^{th} dimension. Each child dimension is at the mercy of their parent dimension. For example, our world can be changed by any intelligent being in the 4^{th} dimension.

No one really knows what the 4^{th} dimension is. Some people think the 4^{th} dimension is time, but I doubt that. The 4^{th} dimension is probably another world similar to our own. Wither this world is 3-d, 4-d or 5-d, I'm not sure. There are probably intelligent beings in this 4^{th} dimension. What they look like I really don't know—they can be aliens with 60 different senses and have intelligence thousands of times smarter than a human being.

The world we live in (this entire universe) is probably contained in some kind of super computer. This world is theoretically a computer software similar to software in a videogame. Either our world was manually created from intelligent programmers in the 4^{th} dimension or copied from another world or both. The computer running this world probably has certain functions and capabilities. In a videogame a programmer has the ability to change all aspects of a game, including: fast forward the game, rewind the game, change objects, delete objects, modify objects, create object properties, change the gravity, change the environment, define object possibilities, define object interactions and so forth. If this holds true, then that means the computer running our world might have a rewind and fast forward function. Basically, the ability for someone to time travel in our world.

Tapping into such a function in an unknown computer isn't going to be easy. Either programmers in the 4^{th} dimension have interfaced this function with some kind of physics law in our world or the function can only be accessed through a programmer in the 4^{th} dimension.

There are actually three ways to travel back in time: 1. A programmer has to hack into the computer that contains our world and manually rewind or fast forward the timeline. 2. There exist some kind of interface between time travel and an unknown physics law. The unknown physics law might be able to take a person back in time. 3. We can communicate with an intelligent person in the 4^{th} dimension to help us travel back in time.

If you think about how time travel is possible, it's quite simple. All atoms are preserved and never destroyed. As time passes these atoms change, creating a new environment. Human beings existed 300 years ago still exist today as scattered atoms in many different places. A person's atom can be a part of a bacteria or other atoms of a person can be a part of a tree. In order to travel back in time 300 years, the computer that encases our world has to structure the atoms exactly how it was 300 years ago. A computer log of billions of years might be contained in the computer. Someone simply has to load the state of our world 300 years ago.

Time travel takes several steps: the person or persons that what to travel in time has to be preserved. The computer then makes a copy of that person or persons into our world (all atoms should be preserved before time traveling). The person or persons has to set the date he/she wants to travel to. Then the computer will structure the atoms backwards—reverse engineering the structure of atoms, the chemical reactions atoms have with other atoms and so forth. This process is equivalent of rewinding a movie backwards. The final step is to insert the person or persons (time travelers) into this new timeline.

There is an easier way to time travel. If we build robots thousands and thousands of times smarter than a human being, these robot's can do all the hard work for us. They can find a way to time travel (if time travel is possible). The three methods to time travel can all be found by the robot. If there exist a Physic law that allows us to time travel, then the robots will find out what that equation is. If the robot can find a way to hack into the computer that stores our world, he can use certain functions to time travel. Lastly, if the robot can find a way to communicate with intelligent species in the 4^{th} dimension, then these intelligent species can help the robot to time travel.

Other Topics

Robots in the Time Machine Predicting the Future

We have learned that the AI program can use fixed functions to predict the future based on pathways it has learned from the environment. The future pathways are stringed together by continuous fragmented pathways in memory. Although this is a traditional way of predicting the future, this method can only predict the future in an “approximate” way. A more powerful way of predicting the future is by using intelligent robots in the time machine called virtual characters to predict the future. The robots in the time machine work in a team like setting, similar to how human beings work in a team like setting, to do “work”. “Work” in this case means predicting the future with pinpoint accuracy.

The main problem facing future prediction is the objective of the prediction. It really depends on what the robots want to predict. In terms of a videogame, the robots might want to predict the future of the game by: playing the game in the slowest time possible, playing the game in the quickest time possible, playing the game as a normal player, playing the game as a beginner or playing the game and deliberately losing. The main objective of the videogame isn't to play the game in the most optimal way possible, it is to play the game based on an objective. With this said, the future prediction should reflect the objective of the robot in the future, whereby future predictions should benefit the robot's objective(s).

By allowing these robots to work together inside the time machine, they can collaborate and debate what the objectives are. They can identify a problem to solve, set goals, plan steps to achieve goals, take action, use trial and error, and solve a problem. Predicting a specific type of future is just one type of work that the robots can do. These robots are not bound by fixed codes and functions, they can work on anything they want to work on. They can solve any problem that they want to solve or to work on any project they want to work on.

Output of Future Predictions

When a robot predicts the future, the future pathways are not necessarily going to be pathways comprising the 4 different data types: 5 sense objects, hidden objects, activated element objects and pattern objects. The output of future predictions can be whatever the robot wants it to be. If the robots wanted to predict the future of an event that will happen in real life, then the future pathways can be a movie sequence (or a movie sequence with multiple angles). If the robots wanted to predict the future of a videogame then the future pathway can be a movie sequence of the game. The movie sequence can be from the point of view of a player (the player watching the TV screen) or it can be a frame-by-frame screen shots of the videogame. The difference between the two movie sequences is that the first movie sequence includes what the robot will sense from all 5 senses: sight, sound, taste, touch and smell. On the other hand, the second movie sequence is just a movie of the TV screen shots of the videogame.

If the robots wanted to predict Super Bowl 89, then the future pathway will be a movie sequence of the game. The difference between this movie sequence and the movie sequence mentioned above is that the movie sequence is created by a team of football producers. The football producers have captured the event Super Bowl 89 in a camera, edited the movie and presented it to viewers. They have captured Super Bowl 89 into a digital format to be played on a TV or a computer monitor. This movie will be the output of the future prediction. The event Super Bowl 89 will be the same, but different football producers will have different movie sequences (different camera angles and shots of the same event).

Sometimes, the robots want to view Super Bowl 89 from a player on the winning team. The robot can predict the future of a player's 5 senses and output future pathways that would include the exact data sensed from the player. These examples show that the output of future predictions can be anything the robot specifies.

Work Done by Robots

The time machine contains pathways from multiple robots. The reason that the time machine is an emulated environment of the real world is because these robots live and experience life in the real world. All pathways from all robots will self-organize itself into one universal brain.

The time machine is also a place where each robot can spend time to do work. A robot can choose to do work by himself or to collaborate with other robots to do work. Free will is the key because each robot chooses to work and nothing is forced upon these robots.

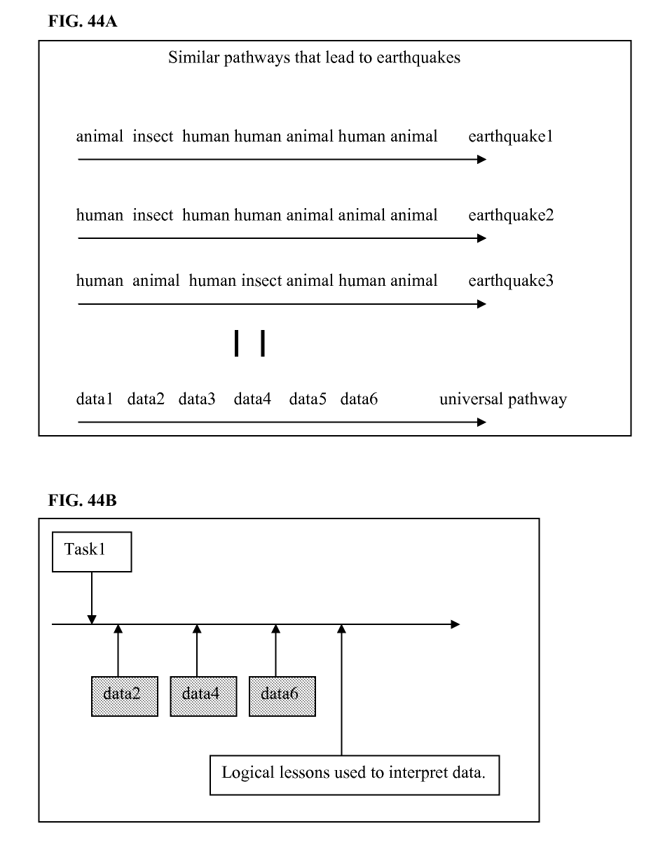

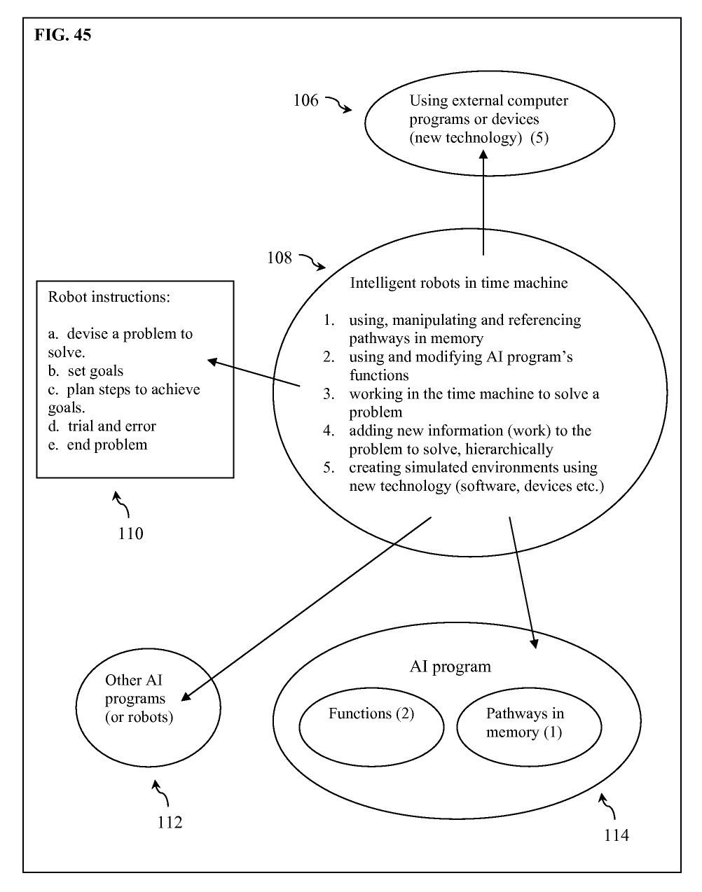

Referring to FIG. 45, multiple robots work together in the time machine to do work (pointer 108). There are certain tools that each robot has access to do work:

1. using, manipulating and referencing pathways in memory

2. using and modifying AI program's functions

3. working in the time machine to solve a problem

4. adding new information (work) to the problem to solve, hierarchically

5. creating simulated environments using new technology (software, devices etc.)

(1) Using, Manipulating and Referencing Pathways in Memory

Pointer 114 shows one AI program (or robot). This AI program comprises functions and pathways in memory. Both are accessible to the robot. The pathways are used to analyze learned data and data that were experienced from the environment. The majority of the knowledge and logic from the environment comes from these pathways. The pathways are also crucial to predicting the future because most of the future pathways are done by stringing continuous pathways together from memory. Other AI programs linked to the time machine can also be accessed (pointer 112).

(2) Using and Modifying AI Program's Functions

The robots working in the time machine are able to modify its own functions. If they find a better computer algorithm or data structure to predict the future then it will be able to modify its own future prediction function. If the robots find a more efficient way of storing information it will modify and change its existing storage function. If the robots find a more efficient way of identifying sequence of images then it will modify and change its existing image function. This gives the robot (or AI program) the ability to adapt and change its' computer codes without the help of external computer programmers.

(3) Working in the Time Machine to Solve a Problem

Referring to pointer 110, each robot has human intelligence or beyond. This means they have the ability to solve complex problems at a human-level. Majority of the time the robots will be using the steps in pointer 110 to solve a problem: (a) devise a problem to solve. (b) set goals. (c) plan steps to achieve goals. (d) trial and error. (e) end problem. They can use any type of scientific method or problem solving skills to solve a problem. All knowledge from all robots are learned from lessons from kindergarten through college.

(4) Adding New Information (Work) to the Problem to Solve, Hierarchically

When doctors attempt to cure cancer they will write research papers or record a video of an experiment to document their work. The robots doing work in the time machine is no exception. They will document their work by researching information related to the problem being solved. They will write report papers, draw diagrams, write books, input data into computer files on information they have found related to the problem. All information, including: strategies, steps, methods, schematic diagrams, knowledge, history logs, future predictions and artistic expression will be put on a “fixed tangible media” so that the robots can look at these materials in the future.

(5) Creating Simulated Environments Using New Technology (Software, Devices Etc.)

Referring to pointer 106, the robots also have access to any software, hardware, electronic devices or machinery to help them solve a problem faster. Technology can be upgraded and encapsulated. The robots can have human intelligence but with the help of new technology they are able to solve any problem regardless of how complex they are. The robots will be using specific types of technology to solve a specific type of problem. If the robots wanted to investigate a crime scene they will use forensic technology to do their investigation. If the robots wanted to write a book they will use a word program to write the book (alternatively, they can write the book using a type writer?).

The robots will use technology to simulate environments on the things they want to predict. Simulating events and objects will play a vital role in predicting the future accurately. For example, the robots can simulate a videogame—they can predict the videogame and how the game will happen in the future by understanding the software behind the videogame. All functions within the software have to be predicted in order to have an accurate understanding of the videogame. This subject matter will be discussed further in the later sections.

### EXAMPLES

The next couple of examples will illustrate how the robots will predict the future for different types of media. These media will include examples that are simple such as a chess game to a media that is more complex such as a videogame. The robots working in the time machine will predict the future for each media and output a future pathway that is precise and accurate.

Chess Game Example

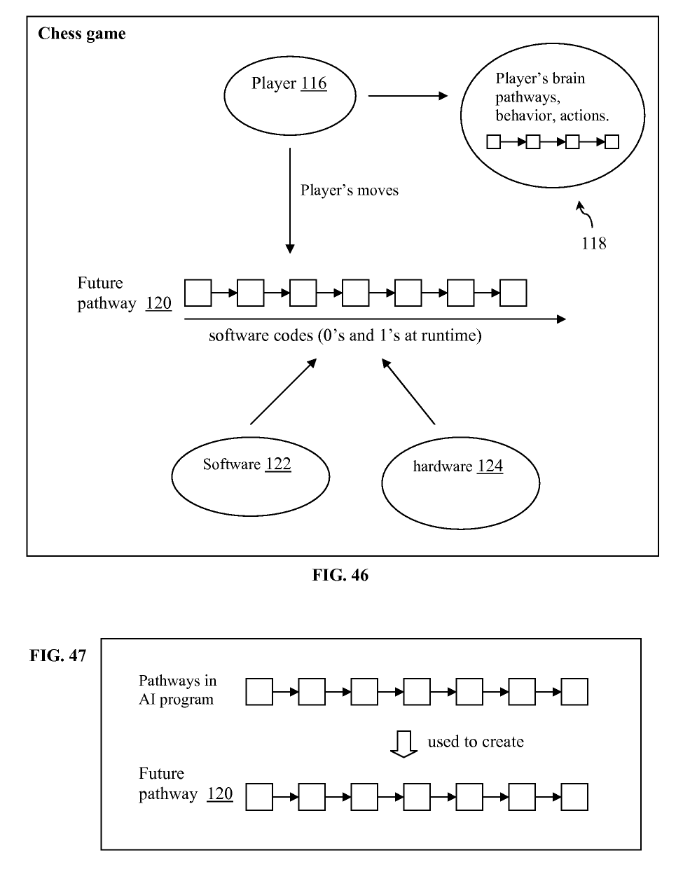

We start off with a simple example to illustrate how the robots can do work to predict future pathways. Referring to FIG. 46, in a simple game of Chess there are two players: the opponent and the player. The robots have to predict the exact moves both the player and the opponent will make in the future. For simplicity purposes imagine the player is a simple robot that can make moves based on a chess game. The opponent is an AI software that have fixed functions and mathematical equations to calculate an optimal move based on the player's moves.

If the robots predict the future of the player and the opponent based on “only” the player's past experiences (pointer 118) then the future predict will not be accurate. It maybe approximate, but it will never be accurate. The player's pathways or experiences in playing the game of chess only record the gameplay of many chess games, but not the actual software that runs the chess game. The AI program can average out all pathways for all chess games and output an approximate future pathway.

Referring to FIG. 46, in order to get a more accurate depiction of future pathways for the game of chess, the entire AI software 122 of the chess game has to be predicted. Not only the software 122, but the hardware 124 that is running the chess game, the players moves 116 and the player's brain 118. After predicting all these factors, the robots will use reasoning and logic to create future pathway 120, which is a simulation of software 122 based on a sequence of predicted moves from player 116.

The robots will take the computer codes from software 122 and run it as a simulation in a computer. Notice that as future pathway 120 is generated sequentially, the software's 0's and 1's are also generated. The robots are taking software 122 and inserting predicted moves from player 116 to simulate a frame-by-frame future pathway 120 of what will happen in the future. The moves of software 122 will influence the moves of player 116 and vice versa, so it is very important to consider these predictions as a group and not as individual predictions. The end result is a perfect and accurate prediction of how the player and opponent will play the chess game in the future.

How exactly do the robots predict the software to the AI chess game? The first way to predict software 122 is by getting a physical copy of the software. The robots will look at the computer codes to understand how software 122 works. Just like how computer programmers have to understand the coding of other computer programmers, the robots working in the time machine has to write down the schematic structure of software 122. When the robots understand how the software works, they can generate frame-by-frame outputs of the chess game. Next, they have to predict the actions of player 116—they have to know what kind of moves player 116 will make based on software 122. This will include predicting the entire brain of player 118, including: all pathways, all memories, all innate behaviors and all brain functions. For simplicity purposes, player 116 is a very simple intelligent object. (Although this may seem impossible the robots can use hierarchical prediction to solve the problem of predicting something complex like a human brain. This subject matter will be discussed in later sections).

A second way of predicting software 122 is by observing pathways from the player's brain 118 and formulating a probable structure of the software. If things are repeated and there are patterns involved in the opponent's moves then the robots can guess what the math equation is or what the functions in software 122 are. By analyzing pathways from the player's brain 118 the robots can guess what the codes are including: if-then statements, and statements, or statements, while-loops, math equations, data structures, search algorithms, function calls and so forth. They will piece together all data they have logically gathered to formulate the entire software 122.

Another way to predict software 122 is by predicting the creative minds of the programmers who has written software 122. This is also an impossible task because in order to predict the writing of software 122 we have to predict “everything else”—which is predicting all past history of all objects and events on planet Earth every fraction of a millisecond. This is the only way to predict software 122 accurately. The most important event is the making of software 122. The robots have to predict what the programmers were thinking of when they started building software 122—what their objective of the software is, how to build the software, who is responsible for writing certain functions, how did they integrate all the codes, what does the code look like, what kind of language were they using, and how does the final codes look like. All these factors have to be predicted in order to predict the codes to software 122. As mentioned earlier, when the robots receive a copy of software 122 they can analyze the software and simulate its functions on a computer.

As the robots generate future pathways 120, they are actually using software 122 to create the frame-by-frame outputs. The 0's and 1's are also generated as future pathway 120 is generated. Not just the software, but player's brain 118 has to be predicted in how it will think as a result of the game. The hardware as well will be predicted as a result of running software 122. All factors: software 122, hardware 124 and player 116 have to be predicted every fraction of a millisecond as the chess game is played in the future. The end result of the prediction is future pathway 120 (all the pathways and experiences from the player's brain 118 are simply “clues” for the robots to create better and more accurate future pathways).

Videogame Example

Let's get into a more complex example: predicting the future of a player playing a videogame. This method is not “only” based on an AI program experiencing playing a videogame and using these pathways to predict what the videogame will be like in the future. This method is based on taking the AI program's pathways and using that as “clues” to predict more accurate future pathways (FIG. 47).

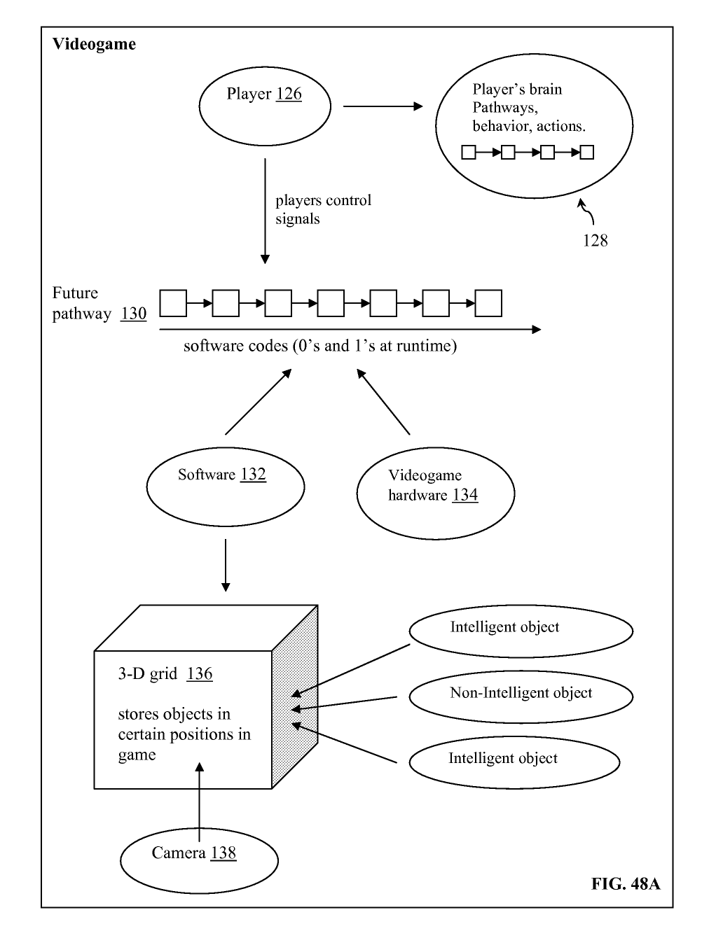

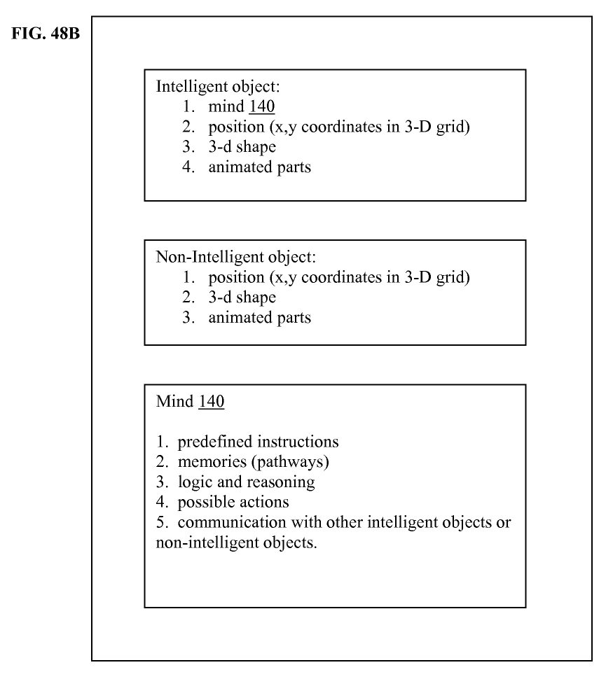

Referring to FIG. 48A, just like the last example, the robots working in the time machine has to predict all factors related to a player playing a videogame. These factors include: predicting player's 126 actions, predicting the player's brain 128, predicting the videogame software 132 and predicting the videogame hardware 134. All predictions will influence each other one way or another and they should all be predicted as a group and not as individual predictions. For example, the player will not know what actions to take until the player looks at the TV screen of the videogame.

Pathways from player 126 will be clues to predicting all the factors listed above (pointer 128). In order to get a more accurate future pathway the codes to software 132 for the videogame has to be predicted. The robots will then analyze and simulate software 132 based on player's 126 actions. Both the player's 126 actions and the simulated videogame will be done on a computer to output a frame-by-frame video display of the videogame called future pathway 130. In this case the future pathway is a movie sequence of the videogame. The future pathway can be anything the robots want it to be. If the robots wanted to output the 5 senses of player 126 playing the videogame, then the future pathway can be the experiences of player 126 in the future playing the videogame.

There are many components to this example; let's start with the software. In a videogame such as Ninja Gaiden for the Playstation 2 there are many functions that make up the software 132. The programmers have created a sequence of environments for the player to play in—play level1 first then play level2 and then play level3 and so forth. Next, the programmers created a 3-d grid 136 to store all objects and events. Some of these objects are non-intelligent objects such as buildings, fire, water, tables, rocks, lights, sky and so forth, while others are intelligent objects such as enemies, human beings, animals, insects and bacteria. Next, the programmers also created a camera 138, which displays the visual screenshots on the TV monitor. Camera 138 is an AI software that follows the player and records the event with the best visibility. The camera 138 changes during runtime as a result of the player or as a result of the software 132. All these functions of software 132 have to be predicted with pinpoint accuracy, so that the robots have a clear understanding of how the videogame really works at a microscopic level. After they predict the software codes they will use software 132 to create simulations in a computer.

The videogame hardware 134 is another factor because the software 132 relies on the hardware 134 in order to generate screen shots on the TV monitor. Sometimes complex mathematical equations are used to generate random or systematic events or objects. For example, if a computer code instructs the hardware to generate fire on a building, then the hardware will use a math equation to generate how the fire will burn on the building. The fire will not burn on the building exactly the same way twice, it is based on a math equation. This problem is crucial because the player's 126 actions are directly linked to what he sees on the TV monitor. If the fire moves to the left the player will jump to the right if the fire moves to the right the player will jump to the left. The only way to predict the future of the exact movement of the fire is to predict the hardware and how it will generate the exact 0's and 1's in the future. An easy example to illustrate this point is by predicting how the hardware generates random numbers. How can the robots know what kind of random number the hardware will output? The answer is to predict the exact state of the software at that moment, predict the exact electrical outputs that are running in and out of the hardware and predict all the transistors, microchips, wires, machinery and embedded software that make the videogame hardware (basically, predicting all atoms in the videogame hardware including electrical discharge, every fraction of a millisecond).

In software 132 there are many intelligent and non-intelligent objects to predict. Some of these objects are predicted easily by observing pathways from player's 126 brain (pointer 128). The robots working in the time machine will analyze and guess what the computer codes are that govern the actions of an intelligent object. For example, if an enemy1 always attacks the player with a sword then the robots can conclude that enemy1 locates the player and attacks with his sword. If enemy1 stops attacking the player when he steps in the water then the robots can conclude further that enemy1 stops and stares at the player when the player steps in the water. This is an easy example of analyzing enemies, for more intelligent enemies the robots have to use complex logic to guess what that intelligent enemy's codes are. The robots can build a brain model of all intelligent objects in a hierarchical manner. First, by predicting universal pathways, then by filling in detail pathways (this subject matter will be discussed further in later sections).

Referring to FIG. 48B, the difference between intelligent and non-intelligent objects is the mind. Non-intelligent objects comprising: position (x,y coordinates in 3-D grid), 3-d shape, animated parts. Intelligent objects comprising: mind 140, position (x,y coordinates in 3-D grid), 3-d shape, animated parts. Mind 140 are simply another function that stores and instruct the intelligent object to take action. Mind 140 comprising: predefined instructions, memories (pathways), logic and reasoning, possible actions, communication with other intelligent objects or non-intelligent objects.

The creativity of the programmers and artists that worked on the videogame has to be predicted. In each intelligent or non-intelligent object the programmers will position that object in certain areas in 3-D grid 136 and at certain situations. The robots have to know where these objects are positioned and at what times. The creative expression of the 3-d shape of objects is also another important factor. What exactly does the object look like in 3-dimension. Some clues of the shape, size, color and actions of an object can be extracted from pathways from the player 126 (pointer 128). However, not “all” creative expressions of the videogame can be extracted based on observation of the game.

The robots will predict objects in software 132 in a hierarchical manner, wherein the most important objects are predicted first before the minor objects are predicted. Pathways in the player's brain 128 structure objects (both intelligent and non-intelligent) in a hierarchical manner. The robots will use this information to predict which object should be predicted first, second, third and so forth.

For a better understanding of the creative aspects of objects in the videogame, the robots have to get a copy of the videogame software 132. The codes will dictate what the objects will look like in 3-d, where they will be positioned, what actions the objects will have and the intelligence of that object (if it exists). The software 132 also decides how the camera 138 will behave according to the controls of the videogame.

If the robots can't get a physical copy of the software 132 they can predict the making of the software by predicting the events that happened in the past related to the creation of that videogame software 132. The robots have to predict each programmers thinking and actions every fraction of a millisecond as they are making the software 132. Every letter they type on the computer, every artistic thought, every movement they make, every action these programmers take in terms of creating this software 132 must be predicted accurately and precisely in order to predict the exact codes to software 132.

After an exact copy of software 132 is predicted the robots can simulate all aspects of the videogame in a computer. They must then predict the actions of player 126. This part is very difficult because player 126 is a human being and in order to predict his actions the robots have to predict all atoms and energy in his brain every fraction of a millisecond. All memories player 126 (pointer 128) have also has to be predicted because past experiences dictate how player 126 will take action in the future.

After software 132 is predicted, whereby a clear understanding of how the videogame works; and the future actions of player 126 is predicted, then the next step for the robots is to simulate both predictions in a computer. By presenting a gameplay for player 126 the robots can observe how player 126 will behave in the future. If the robots present a different gameplay for player 126 a different future will result. The robots will generate more and more future predictions and discuss in a team which predicted future pathway will most likely to happen in the future. They can also use external software to sort out all predicted future pathways to output the most likely future pathway that will happen in the future. The end result is an accurate and precise future pathway 130 that will happen in the future.

More complex videogame examples will include multi-player games or games played over the internet. Each player is a human being and the robots have to predict each player and their brain activities.

Movie Example

Predicting a movie that will happen 10 years into the future is a little tricky, but it is possible to predict. In order for this type of prediction to occur past prediction has to be predicted accurately (especially the current state). All atoms on planet Earth has to be predicted precisely every fraction of a millisecond. If and when this past timeline is completed, then it is possible to predict the future with pinpoint accuracy.

Let's imagine that someone wanted to predict Star Wars 8, which will happen 10 years from now. Currently, the producers of Star Wars have no clue as to what the storyline will be like in the movie. They might take an existing Star Wars book and turn that into a movie in the future but there are no guarantees.

In order to predict a movie that will happen 10 years into the future all atoms on planet Earth must be predicted every fraction of a millisecond. Since tracking all atoms is difficult the robots have to predict the future in a hierarchical manner, wherein the most important objects are predicted first before predicting the least important objects. In terms of this movie, the most important objects are the producers of this movie. All people that are involved (or presumable involved) in this movie will be predicted first. Even the area the movie will be filmed will be predicted first. For example, California must be predicted first before Texas. The reason is because Texas has no movie companies, while most of the movie companies are in California.

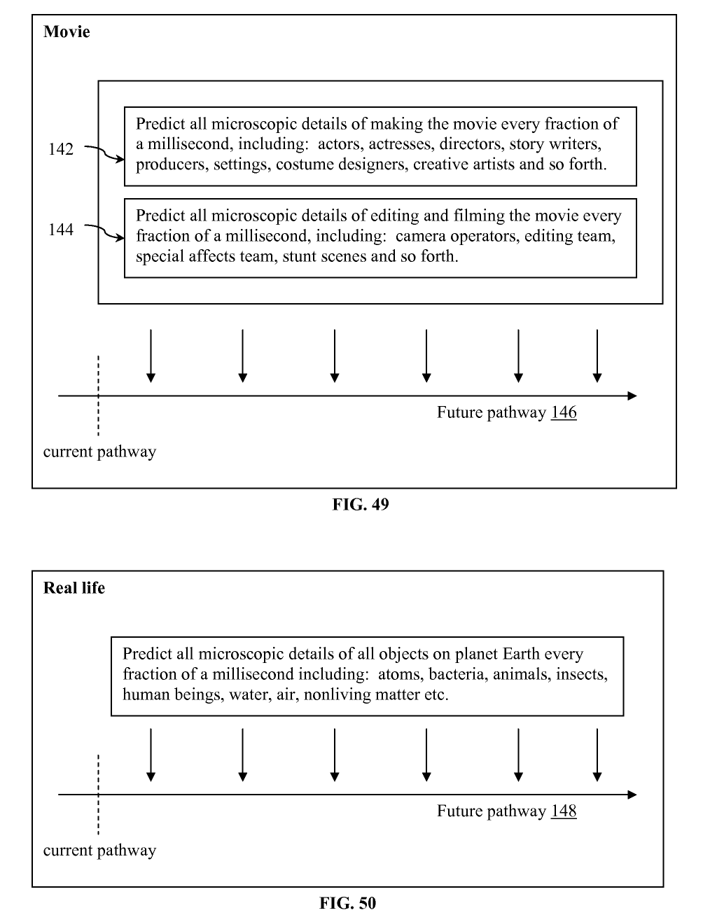

Referring to FIG. 49, future pathway 146 is the events that will happen in the next 10 years and it will lead to the future movie. In order to predict future pathway 146 the robots have to: predict all microscopic details of making the movie every fraction of a millisecond, including: actors, actresses, directors, story writers, producers, settings, costume designers, creative artists and so forth (pointer 142); and predict all microscopic details of editing and filming the movie every fraction of a millisecond, including: camera operators, editing team, special affects team, stunt scenes and so forth (pointer 144).

Real Life Example

The robots can predict actual events that will happen in the future in the real world. Imagine the year is 1990, is it possible to predict that George Bush will be president of the United States in 2001? Referring to FIG. 50 and future pathway 148, it is possible if the robots predict future objects or events at a microscopic level. All objects and events including: atoms, bacteria, insects, air, energy, animals, human beings, inanimate objects and so forth must be predicted accurately and precisely every fraction of a millisecond from 1990 to 2001 (or up until Mr. Bush becomes president).

Future prediction will be done in a hierarchical manner. There are some future events that are coincidental, while others are not. When the robots predict the future of events in real life the more details they predict the more accurate the future prediction becomes. Events such as earthquakes and hurricanes have nothing to do with the activities of people on Earth, they will happen regardless. These are considered events that are destined to happen. A person can move from Texas to California or from Texas to Hawaii, these alternative events won't affect future earthquakes. The earthquake will happen regardless of where this person moves.

The destiny of people can also be predicted. For some events, they happen regardless of what happens in the future. A person can make a decision to be a doctor and this person can reach his/her goals if they follow through regardless of the obstacles he/she faces in life. Some people have their legs amputated, but that doesn't stop them from reaching their goals. Children will go to school starting from grade school, then move on to middle school, next move on to high school. Some people drop out of high school, but the majority of children will follow these steps. People will also grow old and old age happens regardless of what alternative pathways life takes us. As the robots predict the future from real life, some of their prediction will happen while others will not happen (structured in a hierarchical manner). The more details they predict in the future the more accurate their future prediction becomes.

There are some events that are coincidental such as a lottery or random happenstance. It would take intelligence far beyond human-level to predict who will win a lottery 10 years into the future. Back in the 60's, a story writer named Stan Lee was trying to come up with a new superhero character. He was sitting on his chair trying to brainstorm a character when we looked at the window to his right and noticed a spider crawling up the window. This gave Stan Lee the idea of Spiderman. The question I have is: would Stan Lee have created Spiderman if there was no spider on the window? What if the spider was replaced with a bug, would bugman be created? These coincidences are important because they happen and because they happen the world around us is changed dramatically.

Sports Event Example

The robots can also predict Super Bowl 89 in the future (or any sports event). The output of future predictions will have to be a movie of that event—a digital recording of Super Bowl 89 as it will happen in the future. This form of prediction combines the movie example and the real life example mentioned earlier. In order to predict this sports event the robot has to first predict 20 years into the future with pinpoint accuracy. Next, the robots have to predict the football producers who captured Super Bowl 89 in a digital video. The camera man, the editors, the sports casters and the special affects team must be predicted. The end result is the robots outputting a digital video of Super Bowl 89 as its future prediction.

Predicting the Intelligence of a Human Being, Hierarchically

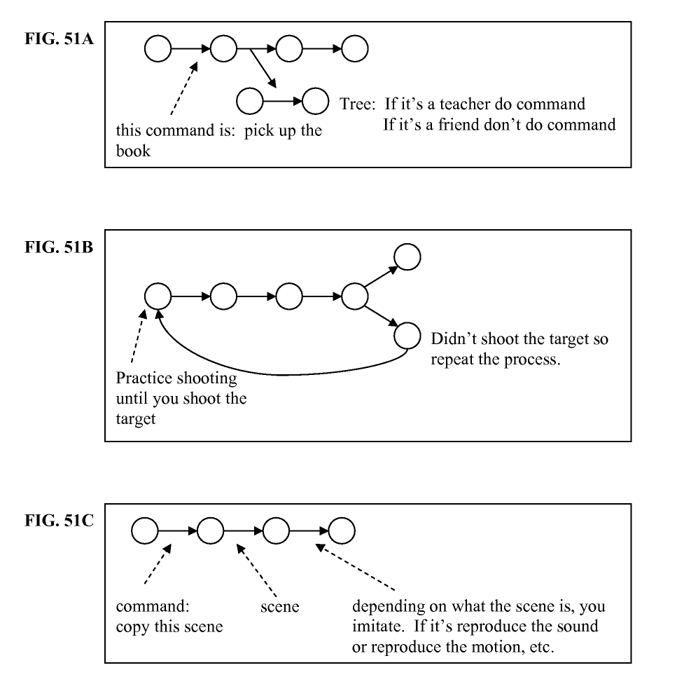

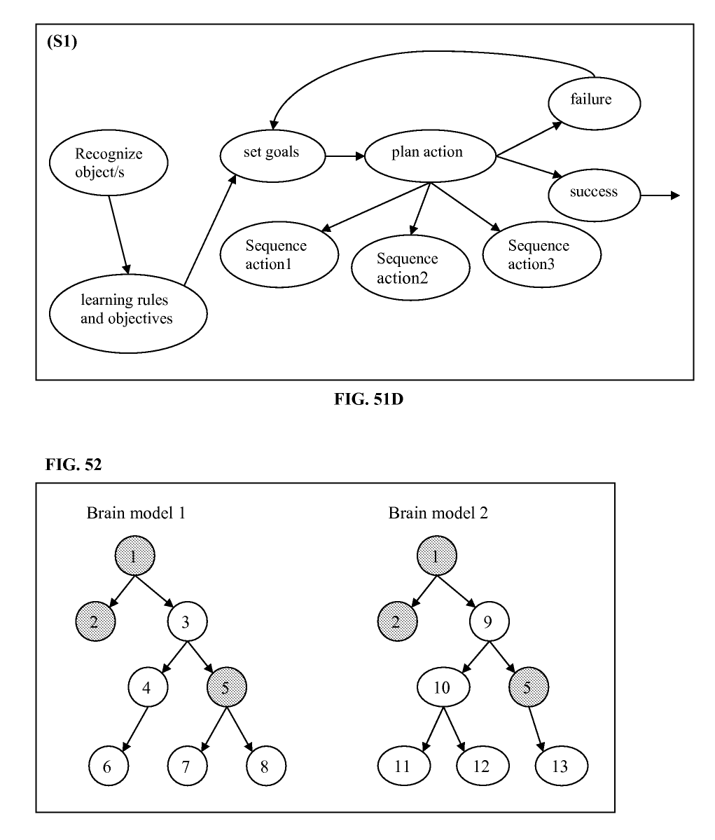

In a human being, the brain structures pathways in a hierarchical manner, wherein pathways go from universal pathways to detailed pathways. The robots in the time machine can observe a human being's actions and devise simple pathways using discrete math and fuzzy logic. Referring to FIGS. 51A-51D, these are universal pathways that a person uses to take action. The job of the intelligent robots working in the time machine is to observe a human being's actions and to devise these universal pathways using both discrete math and fuzzy logic.

Referring to FIGS. 51A-51D, these universal pathways are mainly composed of discrete math functions such as: if-then statements, for-loops, and statements, or statements, while-loops, static data, sequence data or a combination of all discrete math functions. In addition to these discrete math functions the pathways also uses language in a fuzzy logic manner (fuzzy logic in terms of language means different sentences can have the same meaning). Sentences or meaning to sentences are added to the pathways by the robots. Sentences and meaning to sentences is a powerful tool in encapsulating pathways.

Perception and behavior can be observed and a simple type of pathway using discrete math functions can be generated. Of course, the robots have to use runtime intelligence in order to come up with the pathways (a fixed function to create a model of intelligence based on an organisms actions should not be used). The robots will have to define objects and situations in pathways by using language or meaning to language. Meaning to language can also be sight, sound, taste touch, smell objects or a combination of objects. For example, in FIG. 51A, the robots have to define the command which is to pick up the book. Then it has to define the if-then statements: if a teacher gives the command then do it, if a friend gives the command then don't do it. It would be extremely hard to build a fixed function to generate this universal pathway based on a situation.

All perceptions or behaviors have to have a universal pathway to represent it. The robots will have to be able to map out the human beings inner thoughts such as: likes, dislikes, what is cool and not, what is boring, what kind of style to use and so forth. Under certain situations how will the human being behave? Is the human being stubborn? Does he follow the social norm or does he do things differently? What are the values of the human being? What makes that human being angry or happy? If the human being had to choose a random color, what color will he pick? Will that human being buy expensive food or cheap food? All these questions can be answered by observing the human being and each situation can be represented by a universal pathway.

The robots have to predict the systematic or random sequences that the human being will follow. FIG. 51D is an illustration of a popular universal pathway that most human beings use to solve a problem. This diagram outlines how the human being will behave in a systematic way to solve a particular problem. The human being will: identify a problem to solve; set goals; plan steps to achieve goals; modify itself based on trial and error; and repeat certain steps or stop. The robots can observe the actions of a human being and can create universal pathway S1. Also, the probability of each step is also calculated by the robots. For example, if the human being is on a basketball court. The robots observe that the human being is trying to throw the ball into the hoop. They will assume that the human being's goal is to throw the ball into the hoop. The robots will further observe the human being attempting to throw the ball 3 times and each time misses. The 4^{th} time the human being throws the ball the ball goes into the hoop. At this point the human being jumps and cheers, which indicates he has accomplished his goal.

There are two sources that the robots can use to observe the actions of a human being: 1. the pathways learned and stored in the AI program (FIG. 48A and pointer 128). 2. the brain activity of the human being including: all electrical discharges, the intensity of each electrical discharge and the location of each electrical discharge in the human being's brain. The brain activity will be linked to the actions of the human being.

With these two sources the robots can map out the universal pathways first by guessing what the pathways contain. The universal pathways will be mapped out first because it is easier to predict. Next, when a simple brain model is devised for the human being, the robots will try to predict what the detailed pathways for the human being are. Detailed pathways will include the exact data in a pathway in the human being (this will include things like past memory). The whole idea is to copy the entire brain structure of that human being and convert that into a software to better understand how that human being behaves. Every atom in that human being's brain has to be emulated including universal pathways, detailed pathways, the functions of the brain and the innate traits of the brain. Innate traits would include built-in things such as likes, dislikes, attractiveness, ugliness, pain, pleasure and so forth. The robots working in the time machine will create a model of that person's brain in a hierarchical manner.

There are basically 5 things the robots have to predict for a human being: 1. the 5 senses experienced by the human being. 2. the conscious thoughts of the human being. 3. the actions of the human being. 4. the brain functions of the human being. 5. the physical atoms of the human being. Intentions of the human being is different from the actual actions of the human being. The thought of the human being is the instructions to control the body to do certain things. If a human being wanted to swing a golf ball his intentions is to swing the ball so that it will go inside the hole. However, other factors will decide what will happen to the golf ball such as the movement of the body, the golf club, the wind and gravity. These three factors will decide where the golf ball will land: the thought process of the human being; the body movement as a result of electrical signals sent by the brain; and the surrounding environment.

Using Templates to Predict a Brain Model of a Human Being

Since human beings are similar in terms of its brain structure, then the robots can actually classify human beings in terms of a 3-d grid. The more similar the way one human being is from another human being the closer they will be to each other. This 3-d grid not only organizes human beings in the way they think, but also their physical structure and the actions they take. FIG. 52 is a diagram depicting two brain models, each structured in a hierarchical manner. Although in detail both brain models are different, they do share some similarities in the higher levels. Nodes 1, 2 and 5 are the same while the rest are different.

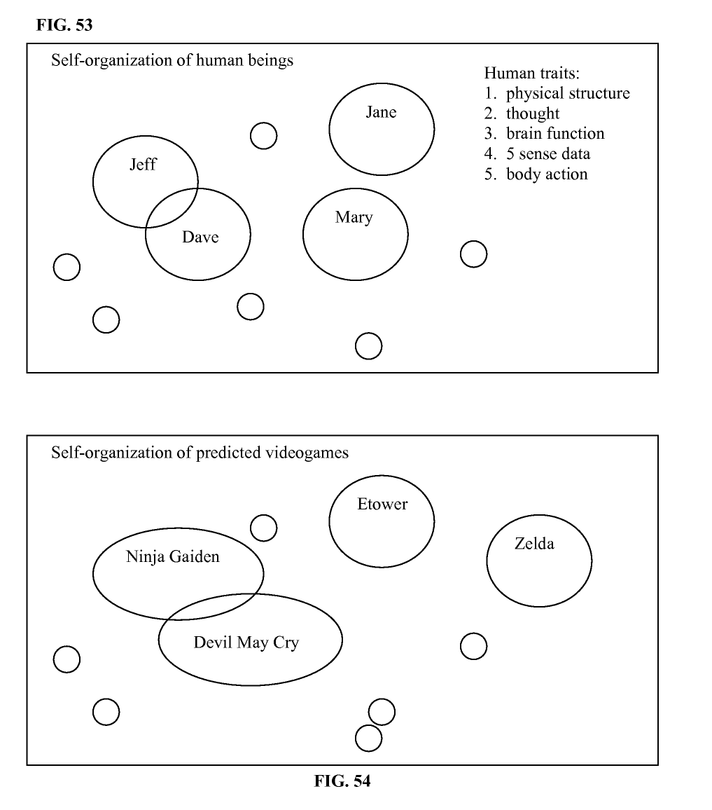

Since models of the brain are structured in a hierarchical manner, the robots can use templates of brain models that are consistent with all human beings. This way the robots don't have to re-analyze certain aspects that are the same for all human beings. This will allow the robots to generate a brain model quicker for each human being (FIG. 53).

Back to the Videogame Example

We can use the same example from the last section to predict future pathways for similar videogames (FIG. 54). If you compare games for the playstation 2 you will notice that certain games are very similar. Games like Ninja Gaiden, Devil May Cry and Castlevania lament are all similar in gameplay. The environment looks the same, the action looks the same, the gravity looks the same, the structure of buildings look the same and so forth. After the robots have solved a particular problem they might be able to store their “work” in a 3-d grid to group similar work together. For example if the robots predicted future pathways for Ninja Gaiden, it can use the template from Ninja Gaiden to predict similar videogames. If Devil May Cry is a similar game to Ninja Gaiden then the robot can use the template from Ninja Gaiden. This way, the robots don't have to re-predict things that they have already predicted. For example, if the robots predicted the hardware for the videogame, then the robots don't have to predict the same hardware for a similar game. The robots only need to predict the details for the similar game (Devil May Cry).

This technique can be applied to any “work” done in the time machine by these intelligent robots. Also, advance computer programs can help in classifying which template to use for a particular problem. This will make work done in the time machine more efficient and repeated work are brought to a minimal.

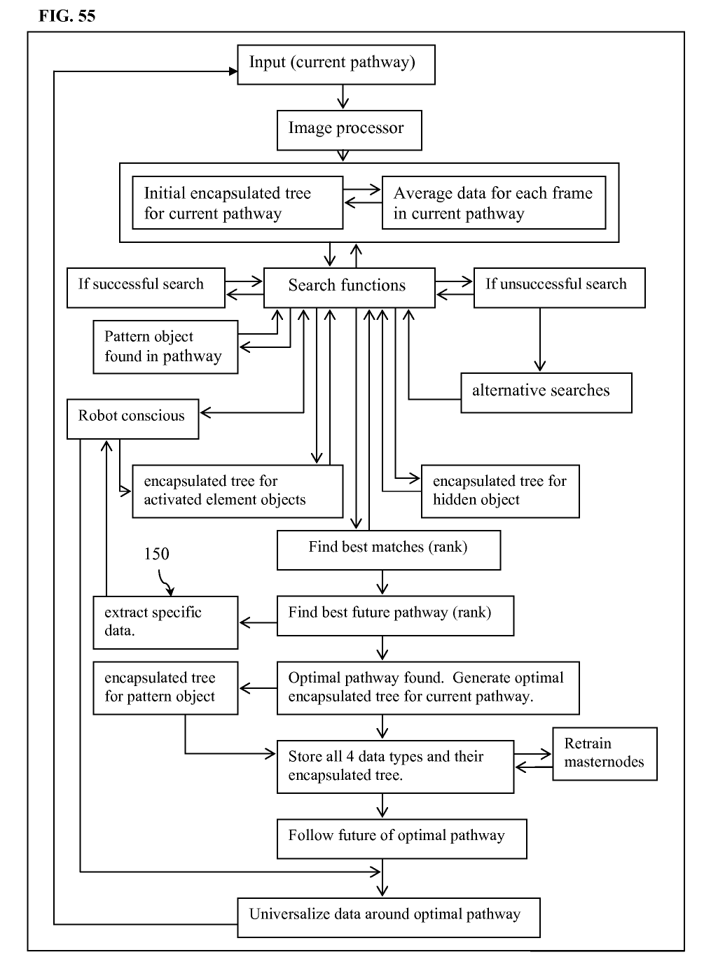

Conclusion: The present invention is similar to previous patent applications filed on the human-level artificial intelligence program. Referring to FIG. 55, the only difference is step 150. After or during the prediction of future pathways, the AI program will extract specific data from the strongest future pathways and insert them into the robot's conscious, whereby the specific data will be known as future element objects and they will be competing with other element objects to be activated in the robot's mind. The specific data extracted from future pathways come from a form of supervised learning, in which a teacher teaches the robot which data in future pathways are important.

The foregoing has outlined, in general, the physical aspects of the invention and is to serve as an aid to better understanding the intended use and application of the invention. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

What is claimed is:

1. A method to create a human robot with psychic abilities, as well as enabling a human robot to access information in a time machine to predict the future accurately and realistically, said robot comprising:
an artificial intelligent computer program repeats itself in a single for-loop to:
receive input from the environment based on the 5 senses called the current pathway,
use an image processor to dissect said current pathway into sections called partial data,
generate an initial encapsulated tree for said current pathway; and prepare variations to be searched,
average all data in said initial encapsulated tree for said current pathway,
execute two search functions, one using breadth-first search algorithm and the other using depth-first search algorithm,
target objects found in memory will have their element objects extracted and all element objects from all said target objects will compete to activate in said artificial intelligent program's mind,
find best pathway matches,
find best future pathway from said best pathway matches and calculate an optimal pathway,
extract specific data from predicted future pathways and insert them into said artificial intelligent program's conscious,
generate an optimal encapsulated tree for said current pathway,
store said current pathway and its' said optimal encapsulated tree in said optimal pathway, said current pathway comprising 4 different data types: 5 sense objects, hidden objects, activated element objects, and pattern objects,
follow future instructions of said optimal pathway,
retrain all objects in said optimal encapsulated tree starting from the root node,
universalize pathways or data in said optimal pathway; and
repeat said for-loop from the beginning;
a 3-dimensional memory to store all data received by said artificial intelligent program;
a long-term memory used by said artificial intelligent program; and
a time machine used by said artificial intelligent program.

2. A method of claim 1, wherein said psychic abilities in said artificial intelligent program comprises the steps of:
extracting specific data from predicted future pathways and inserting them into said artificial intelligent program's conscious, designated as future element objects, to compete with other element objects gathered; and
activating the strongest element objects in said artificial intelligent program's mind.

3. A method of claim 2, wherein said artificial intelligent program's conscious comprising: open activation and hidden activation, in which said open activation is presented in said artificial intelligent program's mind, while said hidden activation is not presented in said artificial intelligent program's mind.

4. A method of claim 3, in which said open activation and hidden activation further comprising pattern object recognition for the purpose of generating logic and reasoning in said artificial intelligent program.

5. A method of claim 2, in which said specific data extracted from predicted future pathways are identified by a form of supervised learning, whereby a teacher will teach said artificial intelligent program what are important data in predicted future pathways.

6. A method of claim 5, wherein said supervised learning uses pattern recognition between predicted future pathways and future events.

7. A method of claim 1, wherein said time machine comprising: a universal brain to store pathways or experiences from multiple robots.

8. A method of claim 7, wherein said robots being at least one of the following: an atom, a bacteria, an insect, an animal, a human being, a super intelligent entity, a non-intelligent object, an encapsulated object, a gas, a solid matter and a plasma.

9. A method of claim 7, in which said pathways or experiences comprises 4 different data types: 5 sense objects, hidden objects, activated element objects and pattern objects, wherein different robot's will comprise different sensed data.

10. A method of claim 9, in which said pathways or experiences for each robot will self-organize in said universal brain comprising 3 factors:
the data traits and data types recorded in pathways belonging to said robot;
the physical structure and motion of said robot recorded in time and 3-d space, wherein said structure and motion of said robot is determined by at least one of the following: analyzing pathways from other robots; and work done by multiple intelligent robots in said time machine; and
the position of said robot recorded in time and 3-d space, wherein said position of said robot is determined by at least one of the following: analyzing pathways from other robots; and work done by multiple intelligent robots in said time machine.

11. A method of claim 7, wherein said robots are living and collecting experiences from the real world.

12. A method of claim 1, wherein said time machine future comprising: a virtual environment whereby intelligent robots are working together to accomplish tasks.

13. A method of claim 12, in which said intelligent robots can work together using a variety of tools, comprising: said universal brain, AI program functions and pathways and external computer software and hardware.

14. A method of claim 13, in which said work being at least one of the following: solving problems, predicting the future, acquiring knowledge, accomplishing tasks and creating new technology.

15. A method of claim 14, wherein work can be stored in a computer as a fixed tangible media.

16. A method of claim 15, wherein said fixed tangible media records at least one of the following: knowledge, systematic steps, strategies, methods and functions, schematic diagrams, history logs, future predictions and artistic expression.

17. A method of claim 1, wherein predicted future pathways comprises work done by said artificial intelligent program in the future; and said work is stored in a fixed tangible media inside said artificial intelligent program's home computer.

18. A method of claim 1, wherein said artificial intelligent program further comprising a 3-dimensional grid to store work done by intelligent robots in the time machine, in a hierarchically manner, whereby similar work are grouped together.

19. A method of claim 1, wherein said artificial intelligent program predicts the future with pinpoint accuracy, the steps comprising:
analyzing pathways from different robots;
predicting aspects of objects and events, hierarchically, said aspects being at least one of the following: physical structure, movement, intelligence and conscious thoughts;
combining and simulating predicted objects and events, hierarchically, in a virtual environment inside a computer; and
outputting desired data based on predicted objects and events.

20. A method of predicting the actions of a human being, hierarchically, by observing brain activity and actions of said human being, the steps comprising:
predicting the pathway structures of said human being's brain, hierarchically, by predicting universal pathways first; and then predicting detailed pathways;
predicting the functions and structure of said human being's brain;
predicting conscious thoughts of said human being based on a variety of situations; and
establishing links between brain activities and said human being's actions.
